(19) United States
(12) Patent Application Publication
(10) Pub. No.: US 2016/0014726 A1
(43) Pub. Date: Jan. 14, 2016

(54) APPARATUS AND METHODS FOR JOINT CHANNEL ESTIMATION AND NON-LINEAR SYMBOL DETECTION IN TD-SCDMA

(71) Applicant: QUALCOMM Incorporated, San Diego, CA (US)

(72) Inventors: Farrokh ABRISHAMKAR, San Diego, CA (US); Sheng-Yuan TU, San Diego, CA (US); Insung KANG, San Diego, CA (US); Bahadir CANPOLAT, Fleet (GB); Lan LAN, San Diego, CA (US); Chien Chung LIN, San Diego, CA (US)

(21) Appl. No.: 14/327,261

(22) Filed: Jul. 9, 2014

(51) Int. Cl. H04W 72/04; H04L 5/00; H04L 25/02

(52) U.S. Cl. CPC H04W 72/042; H04L 25/0204; H04L 5/003; H04W 72/0446

(57) ABSTRACT

Apparatus and methods for wireless communication include receiving, in a time division synchronous code division multiple access (TD-SCDMA) network, a first number of symbols before a midamble, the midamble, and a second number of symbols after the midamble; determining first forward and backward probabilities for a first subset of the first number of symbols and second forward and backward probabilities for a second subset of the second number of symbols; determining first posterior probabilities for the first subset of the first number of symbols and second posterior probabilities for the second subset of the second number of symbols; determining a first target posterior probability and a second target posterior probability; detecting a first target symbol and a second target symbol; and determining a first channel estimate corresponding to the first target symbol and a second channel estimate corresponding to the second target symbol.

### REFERENCE TO CO-PENDING APPLICATIONS FOR PATENT

The present Application for Patent is related to the following co-pending Patent Application:

“APPARATUS AND METHODS FOR NON-LINEAR SYMBOL DETECTION IN TD-SCDMA,” having Attorney Docket No. 141779WO, filed concurrently herewith, assigned to the assignee hereof, and expressly incorporated by reference herein.

### BACKGROUND

Aspects of the present disclosure relate generally to wireless communication systems, and more particularly, to apparatus and methods for joint channel estimation and non-linear symbol detection in Time Division-Synchronous Code Division Multiple Access (TD-SCDMA).

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, in some countries like China, TD-SCDMA is being considered as the underlying air interface in the UTRAN architecture with existing GSM infrastructure as the core network. The UMTS also supports enhanced 3G data communications protocols, such as High Speed Downlink Packet Data (HSDPA), which provides higher data transfer speeds and capacity to associated UNITS networks.

Conventionally, in TD-SCDMA, linear multi-user detection is performed at a receiver. However, linear receivers may not perform well under some channel conditions such as severe channel conditions where the channel impulse response has nulls in the frequency domain. Therefore, there is a need for improved receivers in TD-SCDMA.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method for wireless communication is provided that includes receiving, in a downlink time slot of a time division synchronous code division multiple access (TD-SCDMA) network, a first number of symbols before a midamble, the midamble, and a second number of symbols after the midamble; determining first forward and backward probabilities for a first subset of the first number of symbols and second forward and backward probabilities for a second subset of the second number of symbols; determining first posterior probabilities for the first subset of the first number of symbols and second posterior probabilities for the second subset of the second number of symbols, respectively based on the first forward and backward probabilities and on the second forward and backward probabilities; determining a first target posterior probability corresponding to a first target symbol and a second target posterior probability corresponding to a second target symbol, respectively based on the first posterior probabilities and on the second posterior probabilities; detecting the first target symbol and the second target symbol respectively based on the first target posterior probability and on the second target posterior probability; and determining a first channel estimate corresponding to the first target symbol and a second channel estimate corresponding to the second target symbol, respectively based on the first target symbol and on the second target symbol.

In another aspect, an apparatus for wireless communication is provided that includes a processing system configured to receive, in a downlink time slot of a TD-SCDMA network, a first number of symbols before a midamble, the midamble, and a second number of symbols after the midamble; determine first forward and backward probabilities for a first subset of the first number of symbols and second forward and backward probabilities for a second subset of the second number of symbols; determine first posterior probabilities for the first subset of the first number of symbols and second posterior probabilities for the second subset of the second number of symbols, respectively based on the first forward and backward probabilities and on the second forward and backward probabilities; determine a first target posterior probability corresponding to a first target symbol and a second target posterior probability corresponding to a second target symbol, respectively based on the first posterior probabilities and on the second posterior probabilities; detect the first target symbol and the second target symbol respectively based on the first target posterior probability and on the second target posterior probability; and determine a first channel estimate corresponding to the first target symbol and a second channel estimate corresponding to the second target symbol, respectively based on the first target symbol and on the second target symbol.

In a further aspect, an apparatus for wireless communication is provided that includes means for receiving, in a downlink time slot of a TD-SCDMA network, a first number of symbols before a midamble, the midamble, and a second number of symbols after the midamble; determining first forward and backward probabilities for a first subset of the first number of symbols and second forward and backward probabilities for a second subset of the second number of symbols; determining first posterior probabilities for the first subset of the first number of symbols and second posterior probabilities for the second subset of the second number of symbols, respectively based on the first forward and backward probabilities and on the second forward and backward probabilities; determining a first target posterior probability corresponding to a first target symbol and a second target posterior probability corresponding to a second target symbol, respectively based on the first posterior probabilities and on the second posterior probabilities; detecting the first target symbol and the second target symbol respectively based on the first target posterior probability and on the second target posterior probability; and determining a first channel estimate corresponding to the first target symbol and a second channel estimate corresponding to the second target symbol, respectively based on the first target symbol and on the second target symbol.

In yet another aspect, a computer program product for wireless communication in provided that includes a non-transitory computer-readable medium including code for receiving, in a downlink time slot of a TD-SCDMA network, a first number of symbols before a midamble, the midamble, and a second number of symbols after the midamble; determining first forward and backward probabilities for a first subset of the first number of symbols and second forward and backward probabilities for a second subset of the second number of symbols; determining first posterior probabilities for the first subset of the first number of symbols and second posterior probabilities for the second subset of the second number of symbols, respectively based on the first forward and backward probabilities and on the second forward and backward probabilities; determining a first target posterior probability corresponding to a first target symbol and a second target posterior probability corresponding to a second target symbol, respectively based on the first posterior probabilities and on the second posterior probabilities; detecting the first target symbol and the second target symbol respectively based on the first target posterior probability and on the second target posterior probability; and determining a first channel estimate corresponding to the first target symbol and a second channel estimate corresponding to the second target symbol, respectively based on the first target symbol and on the second target symbol.

To the accomplishment of the foregoing and related ends, the one or more aspects comprise the features hereinafter fully described and particularly pointed out in the claims, The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system according to some present aspects;

FIG. 2 is a diagram illustrating example portions of a downlink time division synchronous code division multiple access (TD-SCDMA) time slot with reference to respective channel estimations according to some present aspects;

FIG. 3 is a block diagram illustrating an example posterior recursion performed at a receiver in some present aspects;

FIG. 4 is a diagram illustrating an example computational flow of a receiver in some present aspects;

FIG. 5 is a diagram illustrating another example computational flow of a receiver in some present aspects;

FIG. 6 is a block diagram illustrating an example joint channel estimation and two-sided posterior recursion performed at a receiver in some present aspects

FIGS. 7-12 are flow charts of example methods of wireless communication in aspects of the wireless communications system of FIG. 1;

FIG. 13 is a diagram of a hardware implementation for an apparatus employing a processing system, including aspects of the wireless communications system of FIG. 1;

FIG. 14 is a diagram illustrating an example of a telecommunications system; including aspects of the wireless communications system of FIG. 1;

FIG. 15 is a diagram illustrating an example of a frame structure in a telecommunications system, in aspects of the wireless communications system of FIG. 1; and

FIG. 16 is a diagram illustrating an example of a Node B in communication with a UE in a telecommunications system, including aspects of the wireless communications system of FIG. 1.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Some present aspects provide joint channel estimation and non-linear symbol detection in Time Division—Synchronous Code Division Multiple Access (TD-SCDMA), For example, some aspects provide a bootstrap coupling between nonlinear detection of the received symbols and adaptive channel estimation in real-time. Accordingly, the present aspects may provide a performance gain of for example, from 2 dB to more than 9 dB, over the conventional receivers that perform multi-user detection. In some aspects, the symbol detection is performed according to the maximum a-posteriori criteria, while the channel estimation is performed. according to the minimum mean-square error criteria.

In some aspects, for data received after the midamble, forward adaptive channel estimation (adaptive channel estimation based on future data) is performed jointly with fixed-lag symbol detection (detecting a symbol based on a fixed number of subsequently received symbols). Further, for data received before the midamble, backward adaptive channel estimation (adaptive channel estimation based on past data) is performed jointly with fixed-lead symbol detection (detecting a symbol based on a fixed number of previously received symbols).

In some aspects, for fixed-lag symbol detection (detecting a symbol based on a fixed number of subsequently received symbols), a recursive Bayesian symbol detector is provided that performs online symbol detection in a time slot without needing to buffer all symbols of that time slot. In these aspects, in order to detect a target symbol and upon receiving a first number of subsequent symbols, the non-linear receiver recursively computes forward and backward probabilities of the first number of received symbols using corresponding transition probabilities. Then, the non-linear receiver determines a target posterior probability based on the forward and backward probabilities and uses the target posterior probability for MAP detection of the target symbol, thereby providing symbol detection by fixed-lag posterior recursions.

In some aspects, for fixed-lead symbol detection (detecting a symbol based on a fixed number of previously received symbols), a recursive Bayesian symbol detector is provided that detects a target symbol based on a second number of previously received symbols by recursively computing forward and backward probabilities of the second number of symbols using corresponding transition probabilities. Then, the non-linear receiver determines a target posterior probability based on the forward and backward probabilities and uses the target posterior probability for MAP detection of the target symbol, thereby providing symbol detection by fixed-lead posterior recursions.

The present aspects may be implemented similar to a turbo decoder and may be easily integrated in dual subscriber identity module (SIM) dual active (DSDA) applications. Also, the present aspects may provide performance improvement compared to conventional linear multi-user receivers. For example, the non-linear receiver in the present aspects may result in performance gain in single cell scenarios with a spreading factor of 1.

The performance gain of the non-linear receiver in the present aspects may depend on the puncturing level used for transmitting the symbols. For example, in some aspects, at a certain block error rate (BLER), a higher performance gain may be achieved at a higher puncturing level.

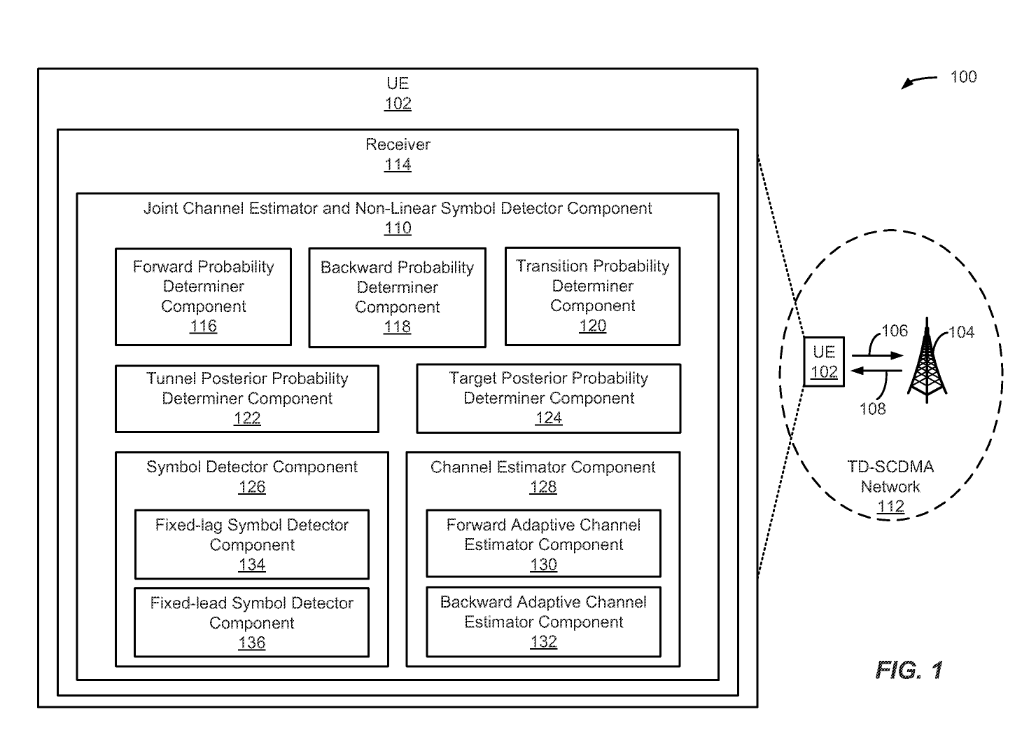

Referring to FIG. 1, a wireless communications system 100 is illustrated with aspects, including joint channel estimator and non-linear symbol detector component 110 configured to improve symbol detection and channel estimation in TD-SCDMA network 112. Wireless communications system 100 includes user equipment (UE) 102 that is receiving downlink signals 108 from base station 104 and transmitting uplink signals 106 to base station 104 in TD-SCDMA network 112.

Conventionally, in TD-SCDMA network 112, the chip rate is 128 megachips per second (Mcps) and the downlink time slot is 675 microseconds (μs) or 874 chips. Table 1 shows an example configuration of chips in a TD-SCDMA downlink time slot.

TABLE 1
An example configuration of chips in a TD-SCDMA downlink time slot

| | | | |
|---|---|---|---|
| Data (352 chips) | Midamble | Data (352 chips) | GP (16 chips) |
| | (144 chips) | | |

As shown in Table 1, there are 144 chips in the midamble of a TD-SCDMA downlink time slot. The midambles are training sequences for channel estimation and power measurements at UE 102. Each midamble can potentially have its own beamforming weights. Also, there is no offset between the power of the midamble and the total power of the associated channelization codes. The TD-SCDMA downlink time slot further includes 704 data chips and 16 guard period (GP) chips.

Conventionally, in TD-SCDMA, linear multi-user detection such as minimum mean-square error (MMSE) detection is performed on downlink signals 108 received at a receiver 114 of UE 102. However, linear receivers may not perform well under some channel conditions. For example, linear receivers may result in high symbol error rate (SER) under severe channel conditions, e.g., When the channel impulse response has nulls in the frequency domain (such as the three tap [1 1 1] channel).

As used herein, for a channel memory of L, a shift register or shift, d^{shift}(m), refers to the vector of transmitted symbols d(m) to d(m−L), in which the last symbol d(m−L) is referred to as the tail, and the vector of the first L symbols d(m) to d(m−L+1) is referred to as the tunnel of symbols, d^{tunnel}(m )

d^{shift} (m)=[d(m) d(m−1) . . . d(m−L+1) d(m−L)] (1×(L+1))

d^{tunnel} (m)=[d(m) d(m−1) . . . d(m−L+1)](1×L)

Further, as used herein. M is the transmitted symbol constellation cardinality (e.g., M=4 for quadrature phase shift keying (QPSK) and M=16 for 16 QPSK).

In some present aspects, a received symbol y(m) in a single cell with a spreading factor of 1 may be modeled as:

$$\begin{matrix}y ( m ) = {\sum }_{i = 0}^{L} h ( m , i ) s ( m - i mod 16 ) d ( m - i ) + v ( m ) \\ = \underline{u} ( m ) \underline{h} ( m ) + v ( m )\end{matrix}$$

$$\underline{u} ( m ) = [ \begin{matrix}u ( m ) & u ( m - 1 ) & … & u ( m - L )\end{matrix} ]$$

$$\underline{h} ( m ) = {[ \begin{matrix}h ( m , 0 ) & h ( m , 1 ) & … & h ( m , L )\end{matrix} ]}^{T}$$

where s(m) is the scrambling sequence with period 16, u(m) is s(m mod 16)*d(m), h(m, i), i=1, . . . , L, is the time-varying channel impulse response (CIR.), and y(m) is additive white Gaussian noise (AWGN).

In some present aspects, receiver 114 of UE 102 includes joint channel estimator and non-linear symbol detector component 110 that operates to address one or more deficiencies of conventional receivers in TD-SCDMA via performing joint channel estimation and online symbol detection in a time slot. Although joint channel estimator and non-linear symbol detector component 110 is illustrated as a part of receiver 111, it should be understood that joint channel estimator and non-linear symbol detector component 110 may be separate from but in communication with, receiver 114. For instance, joint channel estimator and non-linear symbol detector component 110 may be implemented as one or more processor modules in a processor of UE 102, as computer-readable instructions stored in a memory of UE 102 and executed by a processor of UE 102, or some combination of both.

In some aspects, receiver 114 and/or UE 102 and/or joint channel estimator and non-linear symbol detector component 110 include channel estimator component 128 and symbol detector component 126 that, together perform joint channel estimation and online symbol detection. For example, in some aspects, channel estimator component 128 performs channel estimation and sends channel estimate feedback to symbol detector component 126 to be used for symbol detection, while symbol detector component 126 performs symbol detection and sends detected symbol feedback to channel estimator component 128 to be used for channel estimation.

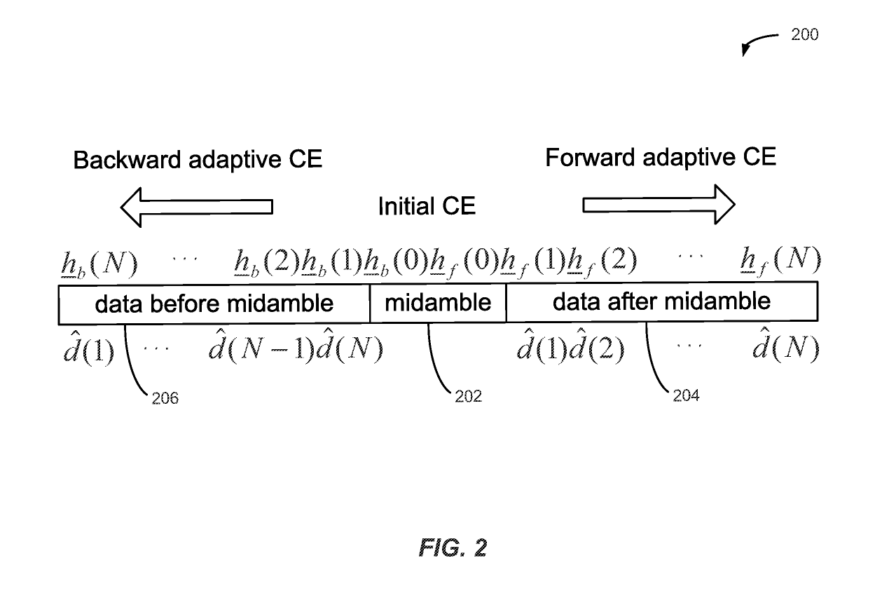

In some present aspects, receiver 114 and/or joint channel estimator and non-linear symbol detector component 110 and/or channel estimator component 128 perform different channel estimations on different portions of a downlink TD-SCDMA time slot. FIG. 2 is a diagram 200 illustrating example portions of a downlink TD-SCDMA time slot with reference to respective channel estimations according to some present aspects. In FIG. 2, block 202 corresponds to the midamble of a TD-SCDMA downlink time slot, block 204 corresponds to data after the midamble in the TD-SCDMA downlink time slot, and block 206 corresponds to data before the midamble in the TD-SCDMA downlink time slot.

In some present aspects, receiver 114 and/or joint channel estimator and non-linear symbol detector component 110 and/or channel estimator component 128 perform initial channel estimation, based on a received midamble in block 202, for data before and after the midamble (h_{b} (0) and h_{f} (0), respectively). Further, as shown in FIG. 2, in some present aspects, for data \hat{d}(1), \hat{d}(2), . . . , \hat{d}(N) after the midamble in block 204, forward adaptive channel estimation (adaptive channel estimation based on future data) is performed to determine corresponding channel estimates h_{f} (1) h_{f} (2) , . . . , h_{f} (N), and for data\hat{d}(1), \hat{d}(2), . . . , \hat{d}(N) received before the midamble in block 206, backward adaptive channel estimation (adaptive channel estimation based on past data) is performed to determine corresponding channel estimates h_{b}(N), h_{b} (N−1), . . . , h_{b} (1) For example, in some aspects, channel estimator component 128 may include forward adaptive channel estimator component 130 that performs forward adaptive channel estimation based on data in block 204, and may further include backward adaptive channel estimator component 132 that performs backward adaptive channel estimation based on data in block 206.

In some aspects, for example, receiver 114 and/or joint channel estimator and non-linear symbol detector component 110 and/or symbol detector component 126 include fixed-lag symbol detector component 134 that performs fixed-lag symbol detection (detecting a symbol based on a fixed number of previously received symbols) based on data after the midamble in block 204. Also, in some aspects, for example, receiver 114 and/or joint channel estimator and non-linear symbol detector component 110 and/or symbol detector component 126 include fixed-lead symbol detector component 136 that performs fixed-lead symbol detection (detecting a symbol based on a fixed number of previously received symbols) based on data before the midamble.

In some aspect, for example, for data received after the midamble, forward adaptive channel estimator component 130 and fixed-lag symbol detector component 134, together, perform joint forward adaptive channel estimation and fixed-lag symbol detection. Also, in some aspects, for example, for data received before the midamble, backward adaptive channel estimator component 132 and fixed-lead symbol detector component 136, together, perform backward adaptive channel estimation jointly with fixed-lead symbol detection.

In some aspects, for example, during a current time slot, fixed-lag symbol detector component 134 detects a symbol d(m) upon receiving y(m) and a number of subsequent symbols, e.g., y(m+1) up to y(m+K), but without waiting to receive all symbols in that time slot. In these aspects, a fixed-lag MAP detection, \hat{d} (m), of symbol d(m) may be modeled as:

$$\hat{d} ( m ) = arg {max}_{d ( m )} Pr ( d ( m ) \vert {\underline{y}}_{1}^{m + K} )$$

where the function “Pr(A|B)” denotes “probability of event A given event B,” and yₘⁿ is the vector of received symbols y(m) to y(n):

yₘⁿ=[y(m) y(m+1) . . . y(n)]

In some aspects, for example, fixed-lead symbol detector component 136 detects a symbol d(N−m) based on y(N+L−m−K) up to y(N+L) in these aspects, a fixed-lead MAP detection, \hat{d}(N−m), of symbol \hat{d}(N−m) may be modeled as:

\hat{d}(N−m)=arg max Pr (d(N−m)|y_{N+L-m-K}^{N+L})

In some present aspects, in order to perform fixed-lag and fixed-lead MAP detections recursively, a forward probability, α (m), of symbol d(m) may be modeled as:

$$\begin{matrix}α ( m ) = Pr ( {\underline{d}}^{tunnel} ( m ) , {\underline{y}}_{1}^{m} ) \\ = {\sum }_{d ( m - L )} Pr ( {\underline{d}}^{tunnel} ( m ) , d ( m - L ) , {\underline{y}}_{1}^{m} ) \\ = {\sum }_{d ( m - L )} Pr ( {\underline{d}}^{tunnel} ( m ) , {\underline{d}}^{tunnel} ( m - 1 ) , {\underline{y}}_{1}^{m} ) \\ = {\sum }_{d ( m - L )} Pr ( {\underline{d}}^{tunnel} ( m - 1 ) , {\underline{y}}_{1}^{m - 1} ) \\ Pr ( {\underline{d}}^{tunnel} ( m ) , y ( m ) \vert {\underline{d}}^{tunnel} ( m - 1 ) , {\underline{y}}_{1}^{m - 1} ) \\ = {\sum }_{d ( m - L )} Pr ( {\underline{d}}^{tunnel} ( m - 1 ) , {\underline{y}}_{1}^{m - 1} ) \\ Pr ( {\underline{d}}^{tunnel} ( m ) , y ( m ) \vert {\underline{d}}^{tunnel} ( m - 1 ) ) \\ = {\sum }_{d ( m - L )} α ( m - 1 ) γ ( m - 1 , m )\end{matrix}$$

where γ (m−1, m) is the transition probability of symbol d(m):

γ(m−1, m)=Pr (d^{tunnel} (m), y (m)|d^{tunnel} (m−1))

Further, in some present aspects, backward probability, β(m−1), of symbol d(m−1) may be modeled as:

$$\begin{matrix}β ( m - 1 ) = Pr ( {\underline{y}}_{m}^{N + L} \vert {\underline{d}}^{tunnel} ( m - 1 ) ) \\ = {\sum }_{d ( m )} Pr ( d ( m ) , {\underline{y}}_{m}^{N + L} \vert {\underline{d}}^{tunnel} ( m - 1 ) ) \\ = {\sum }_{d ( m )} Pr ( {\underline{d}}^{tunnel} ( m ) , {\underline{y}}_{m}^{N + L} \vert {\underline{d}}^{tunnel} ( m - 1 ) ) \\ = {\sum }_{d ( m )} Pr ( {\underline{d}}^{tunnel} ( m ) , y ( m ) \vert {\underline{d}}^{tunnel} ( m - 1 ) ) \\ Pr ( {\underline{y}}_{m + 1}^{N + L} \vert {\underline{d}}^{tunnel} ( m ) , {\underline{d}}^{tunnel} ( m - 1 ) , y ( m ) ) \\ = {\sum }_{d ( m )} Pr ( {\underline{d}}^{tunnel} ( m ) , y ( m ) \vert {\underline{d}}^{tunnel} ( m - 1 ) ) \\ Pr ( {\underline{y}}_{m + 1}^{N + L} \vert {\underline{d}}^{tunnel} ( m ) ) \\ = {\sum }_{d ( m )} γ ( m - 1 , m ) β ( m )\end{matrix}$$

Accordingly, in these aspects, receiver 114 and/or joint channel estimator and non-linear symbol detector component 110 include transition probability determiner component 120 that determines transition probabilities of the symbols, and also include forward probability determiner component 116 and backward probability determiner component 118 that, respectively, recursively determine forward and backward probabilities of the symbols according to:

$$α ( m ) = {\sum }_{d ( m - K )} α ( m - 1 ) γ ( m - 1 , m )$$

$$β ( m - 1 ) = {\sum }_{d ( m )} γ ( m - 1 , m ) β ( m )$$

In some aspects, the initial conditions for the recursions of forward and backward probabilities are set, respectively, as:

$$α ( 0 ) = \frac{1}{{M}^{L}}$$

$$β ( m + K ) = α ( m + K )$$

In some aspects, receiver 114 and/or joint channel estimator and non-linear symbol detector component 110 include tunnel posterior probability determiner component 122 that determines a tunnel posterior probability for fixed-lag posterior recursion, Pr(d^{tunnel} (m+L−1)|y^{m+K}), based on the product of forward and backward probabilities of the most recent symbol of the tunnel of symbols d^{tunnel} (m+L−1), where:

$$Pr ( {\underline{d}}^{tunnel} ( m + L - 1 ) \vert {\underline{y}}_{1}^{m + K} ) = \frac{1}{λ} Pr ( {\underline{d}}^{tunnel} ( m + L - 1 ) , {\underline{y}}_{1}^{m + k} ) = \frac{1}{λ} Pr ( {\underline{d}}^{tunnel} ( m + L - 1 ) , {\underline{y}}_{1}^{m + L - 1} ) Pr ( {\underline{y}}_{m + L}^{m + k} \vert {\underline{d}}^{tunnel} ( m + L - 1 ) , {\underline{y}}_{1}^{m + L - 1} ) = \frac{1}{λ} Pr ( {\underline{d}}^{tunnel} ( m + L - 1 ) , {\underline{y}}_{1}^{m + L - 1} ) Pr ( {\underline{y}}_{m + L}^{m + K} \vert {\underline{d}}^{tunnel} ( m + L - 1 ) ) = \frac{1}{λ} α ( m + L - 1 ) β ( m + L - 1 )$$

where λ is a constant and the tunnel of symbols d^{tunnel} (m+−1) is:

d^{tunnel} (m+L−1)=[d(m+L−1) d(m+L−2) . . . d (m)]

In some aspects, for example, tunnel posterior probability determiner component 122 also determines a tunnel posterior probability for fixed-lead posterior recursion, Pr (d^{tunnel} (N−m)|y_{N+L-m-K}^{N+L}), based on the product of forward and backward probabilities of the most recent symbol of the tunnel of symbols d^{tunnel} (N−m), where:

$$Pr ( {\underline{d}}^{tunnel} ( N - m ) \vert {\underline{y}}_{N + L - m - K}^{N + L} ) = \frac{1}{λ} Pr ( {\underline{d}}^{tunnel} ( N - m ) , {\underline{y}}_{N + L - m - K}^{N + L} ) = \frac{1}{λ} Pr ( {\underline{d}}^{tunnel} ( N - m ) , {\underline{y}}_{N + L - m - K}^{N - m} ) Pr ( {\underline{y}}_{N - m + 1}^{N + L} \vert {\underline{d}}^{tunnel} ( N - m ) , {\underline{y}}_{N + L - m - K}^{N - m} ) = \frac{1}{λ} Pr ( {\underline{d}}^{tunnel} ( N - m ) , {\underline{y}}_{N + L - m - K}^{N - m} ) Pr ( {\underline{y}}_{N - m + 1}^{N + L} \vert {\underline{d}}^{tunnel} ( N - m ) ) = \frac{1}{λ} α ( N - m ) β ( N - m )$$

In some present aspects, receiver 114 and/or non-linear symbol detector component 110 include target posterior probability determiner component 124 that determines a target posterior probability for fixed-lag posterior recursion, Pr(d(m)|y₁^{m+K}), for a target symbol d(m) by marginalizing over the symbols of the tunnel of symbols d^{tunnel} (m+L−1) except for the target symbol d(m), which is equivalent to sum/multiplication over the forward and backward probabilities of the symbols of the tunnel of symbols d^{tunnel}(m+L−1) except for the target symbol d(m), where:

$$\begin{matrix}Pr ( d ( m ) \vert {\underline{y}}_{1}^{m + K} ) = {\sum }_{{\underline{d}}^{tunnel} ( m + L - 1 ) \backslash d ( m )} Pr ( {\underline{d}}^{tunnel} ( m + L - 1 ) \vert {\underline{y}}_{1}^{m + K} ) \\ = \frac{1}{λ} {\sum }_{{\underline{d}}^{tunnel} ( m + L - 1 ) \backslash d ( m )} α ( m + L - 1 ) β ( m + L - 1 )\end{matrix}$$

Accordingly, in these aspects, fixed-lag symbol detector component 134 performs fixed-lag MAP detection of the target symbol d(m) according to:

$$\hat{d} ( m ) = arg {max}_{d ( m )} {\sum }_{{\underline{d}}^{tunnel} ( m + L - 1 ) \backslash d ( m )} α ( m + L - 1 ) β ( m + L - 1 )$$

Further, in some aspects, for example, target posterior probability determiner component 124 also determines a target posterior probability for fixed-lead posterior recursion, Pr(d(N−m)|y_{N+L-m-K}^{N+L}), for a target symbol d(N−m) by marginalizing over the symbols of the tunnel of symbols d^{tunnel}(N−m) except for the target symbol d(N−m), which is equivalent to sum/multiplication over the forward and backward probabilities of the symbols of the tunnel of symbols d^{tunnel}(N−m) except for the target symbol d(N−m), where:

$$Pr ( d ( N - m ) \vert {\underline{y}}_{N + L - m - K}^{N + L} ) = {\sum }_{{\underline{d}}^{tunnel} ( N - m ) \backslash d ( N - m )} Pr ( {\underline{d}}^{tunnel} ( N - m ) \vert {\underline{y}}_{N + L - m - K}^{N + L} ) = \frac{1}{λ} {\sum }_{{\underline{d}}^{tunnel} ( N - m ) \backslash d ( N - m )} α ( N - m ) β ( N - m )$$

where for target symbol d (N−m),

d^{tunnel} (N−m)=[d (N−m) d(N−m−1) . . . s (N−m−L+1)]

and the initial conditions for fixed-lead posterior recursion are:

$$β ( N + L ) = \frac{1}{{M}^{L}}$$

$$α ( N + L - m - K - 1 ) = β ( N + L - m - K - 1 )$$

Accordingly, in these aspects, fixed-lead symbol detector component 136 performs fixed-lead MAP detection of the target symbol d(N−m) according to:

$$\hat{d} ( N - m ) = arg {max}_{d ( N - m )} {\sum }_{{\underline{d}}^{tunnel} ( N - m ) \backslash d ( N - m )} α ( N - m ) β ( N - m )$$

In some aspects, for example, UE 102 and/or receiver 114 and/or joint channel estimator and non-linear symbol detector component 110 perform joint adaptive channel estimation and symbol detection by two-sided posterior recursion (fixed-lead and fixed-lead posterior recursions).

For example, in some aspects, for joint backward adaptive channel estimation and fixed-lead posterior recursion based on data before the midamble, UE 102 and/or receiver 114 and/or joint channel estimator and non-linear symbol detector component 110 use the detected symbols from fixed-lead symbol detector component 136 to reconstruct received chip û(N+L−m) and then send û(n+L−m) to backward adaptive channel estimator component 132 which recursively determines backward adaptive channel estimates h_{b} (m+1) according to:

h_{b}(m+1)=h_{b}(m)+μu^{H}(N+L−m)[y(N+L−m)−û(N÷L−m)H_{b}(m)]m=0,1, . . . ,N−1

Further, in some aspects, for example, for joint forward adaptive channel estimation and fixed-lag posterior recursion based on data after the midamble, UE 102 and/or receiver 114 and/or joint channel estimator and non-linear symbol detector component 110 use the detected symbols from fixed-lag symbol detector component 134 to reconstruct received chip \hat{u}(m) and then send \hat{u}(m) to forward adaptive channel estimator component 131) which recursively determines backward adaptive channel estimates h_{f} (m) according to:

h_{f}(m)=h_{f}(m−1)+μû^{H}(m)[y(m)−û(m)h_{f}(m−1)]m=1, 2, . . . ,N

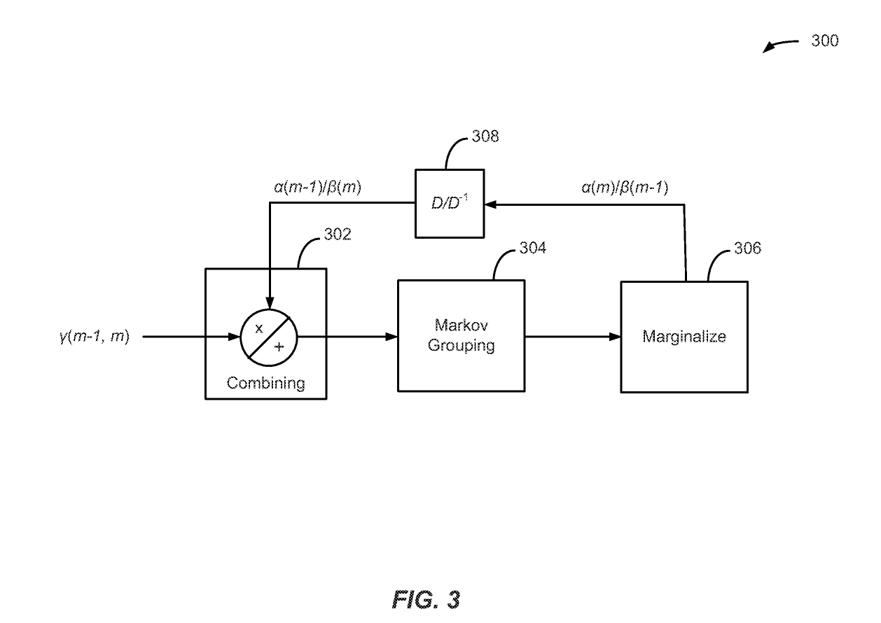

FIG. 3 shows an example block diagram 300 of a process executed by UE 102 and/or receiver 114 and/or joint channel estimator and. non-linear symbol detector component 110 for determining a target posterior probability of a received symbol d(m) by recursively deriving forward and backward probabilities of symbols in a single input single output (SISO) first order auto regressive (ARI) model. At each iteration, at block 302, forward probability determiner component 116 and backward probability determiner component 118 perform a recursion of a respective one of the forward and backward probabilities, by combining (e.g. multiplying or equivalently adding in the logarithmic domain) the transition probability (determined by transition probability determiner component 120) with the forward. and backward probabilities as follows:

$$α ( m ) = {\sum }_{d ( m - k )} α ( m - 1 ) γ ( m - 1 , m )$$

$$β ( m - 1 ) = {\sum }_{d ( m )} γ ( m - 1 , m ) β ( m )$$

Then, at block 304, tunnel posterior probability determiner component 122 performs Markov grouping on the forward and backward probabilities to group those probabilities that correspond to the same tunnel of symbols that has, as its tail, the symbol that is being detected.

Subsequently, at block 306, target posterior probability determiner component 124 performs marginalization on the forward and backward probabilities over the tunnel of symbols except for the symbol that is being detected, to derive a target posterior for the symbol that is being detected.

Finally, at block 308, receiver 114 and/or joint channel estimator and non-linear symbol detector component 110 send delayed forward probabilities and advanced backward probabilities to the next iteration.

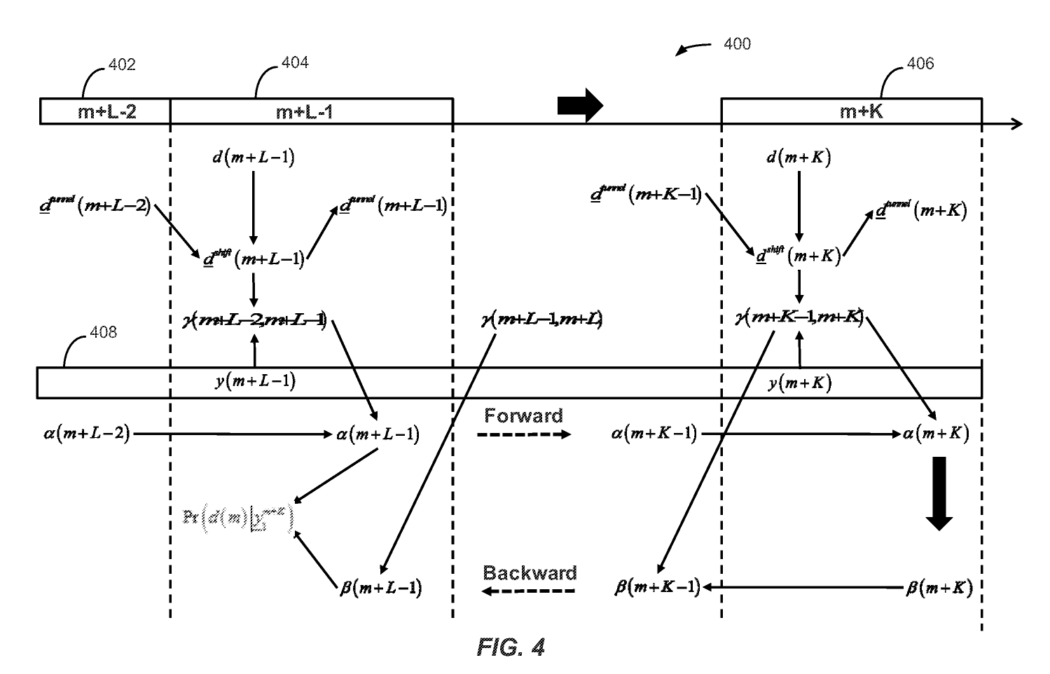

FIG. 4 shows an example computational flow 400 with reference to received symbols 408, executed by LIE 102 and/or receiver 114 and/or joint channel estimator and non-linear symbol detector component 110 for determining a target posterior probability of a target symbol d(m) by recursively deriving forward and backward probabilities of symbols, according to some present aspects,

Computational flow 400 includes portions 402, 404, 406 corresponding to the flow of computations at receiver 114 and/or joint channel estimator and non-linear symbol detector component 110, with reference to symbol indices m+L−2 (index of received symbol y(m+L−2)), m+L−1 (index of received symbol y(m+L−1)), and m+K (index of received symbol y(m+K)), respectively.

In portion 402, index m+L−2 represents an initial state in which forward probability determiner component 116 determines an initial forward probability, for example, according to a uniform distribution, Also, in portion 402, receiver 114 and/or joint channel estimator and non-linear symbol detector component 110 may determine an initial detected tunnel of symbols for this state which may include, for example, null or random entries.

Portion 404 follows portion 402 and corresponds to the computations performed with reference to subsequent index m+L−1. According to the system model in the present aspects, in portion 404, based on the respective symbol, d(m+L−1), and the tunnel of symbols of the previous portion, d^{tunnel}(m+L−2), receiver 114 and/or joint channel estimator and non-linear symbol detector component 110 determine the new shift, d^{shift}(m+L−1). Also, based on the new shift, receiver 114 and/or joint channel estimator and non-linear symbol detector component 110 determine the new tunnel of symbols d^{tunnel}(m+L−1). Then, based on the new shift and the received symbol y(m+L−1), transition probability determiner component 120 determines the transition probability γ(m+L−2,m+L−1). Subsequently, forward probability determiner component 116 determines the forward probability α(m+L−1) based on the transition probability γ(m+L−2, m+L−1) and the forward probability of the previous portion α(m+L−2).

Computational flow 400 may include other successive portions (not shown), where in each portion, similar computations are performed by forward. probability determiner component 116 based on a corresponding received symbol and a corresponding predecessor portion.

The last portion 406 corresponds to the computations performed with reference to index m+K. In portion 406, backward probability determiner component 118 uses the last forward probability, α(m+K), as an initial state for the backward probability β(m+K). Then, backward probability determiner component 118 performs backward iterations of backward probabilities by determining the backward probability of each portion based on the backward and transition probabilities of the successor portion, until reaching back to portion 404.

In portion 404, after backward probability determiner component 118 determines the backward probability β(m+L−1), target posterior probability determiner component 124 determines a target posterior probability, Pr(d(m)|y₁^{m+K}), for symbol d(m) based on marginalization over forward and backward probabilities α(m+L−1) and β(m+L−1).

Accordingly, in some aspects, for example, fixed-lag symbol detector component 136 may perform fixed-lag MAP detection of symbol d(m) based on target posterior probability Pr(d(m)|y₁^{m+K}).

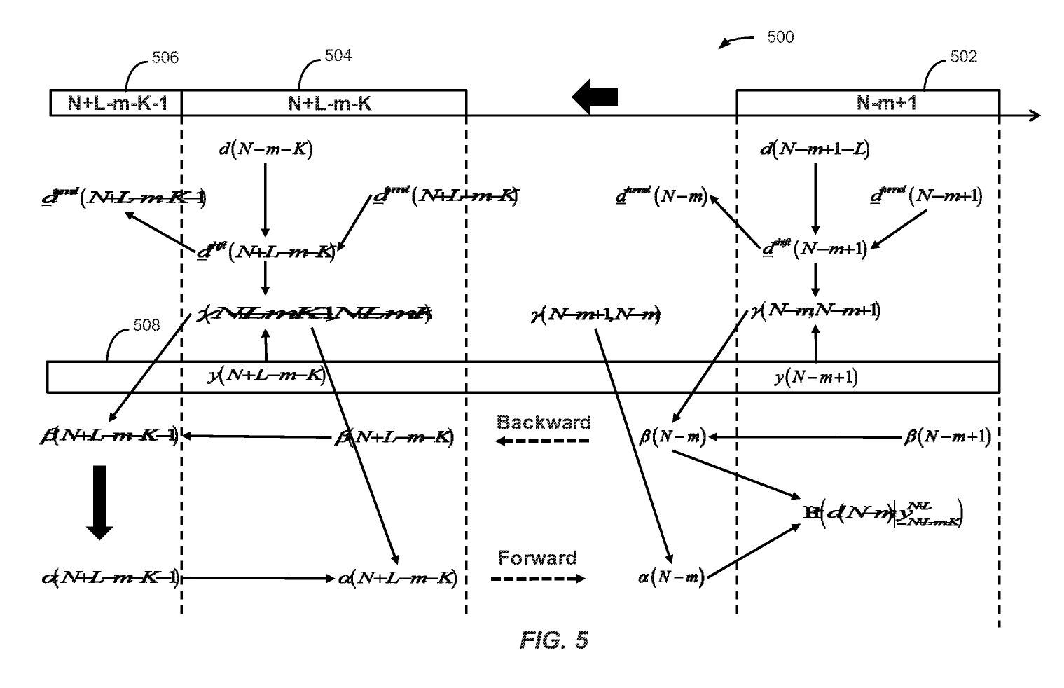

FIG. 5 shows another example computational flow 500 with reference to received symbols 508, executed by UE 102 and/or receiver 114 and/or joint channel estimator and non-linear symbol detector component 110 for determining a target posterior probability of a target symbol d(N−m) by recursively deriving forward and backward probabilities of symbols, according to some present aspects.

Computational flow 500 includes portions 502, 504, 506 corresponding to the flow of computations at receiver 114 and/or joint channel estimator and non-linear symbol detector component 110, with reference to symbol indices N−m+1 (index of received symbol y(N−m+1)), N+L−m−K (index of received symbol y(N+L−m−K)), and N+L −m−K−1 (index of received symbol y(N+L−m−K−1)), respectively.

In portion 502, index N−m+1 represents an initial state in which backward probability determiner component 118 determines an initial backward probability, for example, according to a uniform distribution. Also, in portion 502, receiver 114 and/or joint channel estimator and non-linear symbol detector component 110 may determine an initial detected tunnel of symbols for this state which may include, for example, null or random entries.

According to the system model in the present aspects, in portion 502, based on symbol d(N−m+1−L), and tunnel of symbols d^{tunnel}(N−m+1), receiver 114 and/or joint channel estimator and non-linear symbol detector component 110 determine shift d^{shift}(N−m+1). Also, based on shift d^{shift}(N−m+1), receiver 114 and/or joint channel estimator and non-linear symbol detector component 110 determine tunnel of symbols d^{tunnel}(N−m). Then, based on shift d^{shift}(N−m+1) and received symbol y(N−m+1), transition probability determiner component 120 determines the transition probability γ(N−m, N+1). Subsequently, backward probability determiner component 118 determines backward probability β(N−m) based on transition probability γ(N−m, N−m+1) and the backward probability corresponding to a successor index N−m+1, that is backward probability β(N−m+1).

Computational flow 500 may include other portions (not shown), where in each portion, similar computations are performed by backward probability determiner component 118 based on a corresponding received symbol and a corresponding successor portion, up to and including portion 504 corresponding to index N+L−m−K.

The last portion 506 corresponds to the computations performed with reference to index N+L−m−K−1. In portion 506, forward probability determiner component 116 uses the last backward probability, β(N+L−m−K−1), as an initial state for the forward probability α(N+L−m−K−1). Then, forward probability determiner component 116 performs forward iterations of forward probabilities by determining the forward probability of each portion based on the forward probability of a previous portion and the transition probability of a current portion, until reaching back to portion 502.

In portion 502, target posterior probability determiner component 124 determines target posterior probability Pr(d(N−m)|y_{N+L-m-K}^{N+L}) for symbol d(N−m) based on marginalization over forward and backward probabilities α(N−m) and β(N−m).

Accordingly, in some aspects, for example, fixed-lead. symbol detector component 138 may perform fixed-lead MAP detection of symbol d(N−m) based on target posterior probability Pr(d(N−m)|y_{N+L-m-K}^{N+L}).

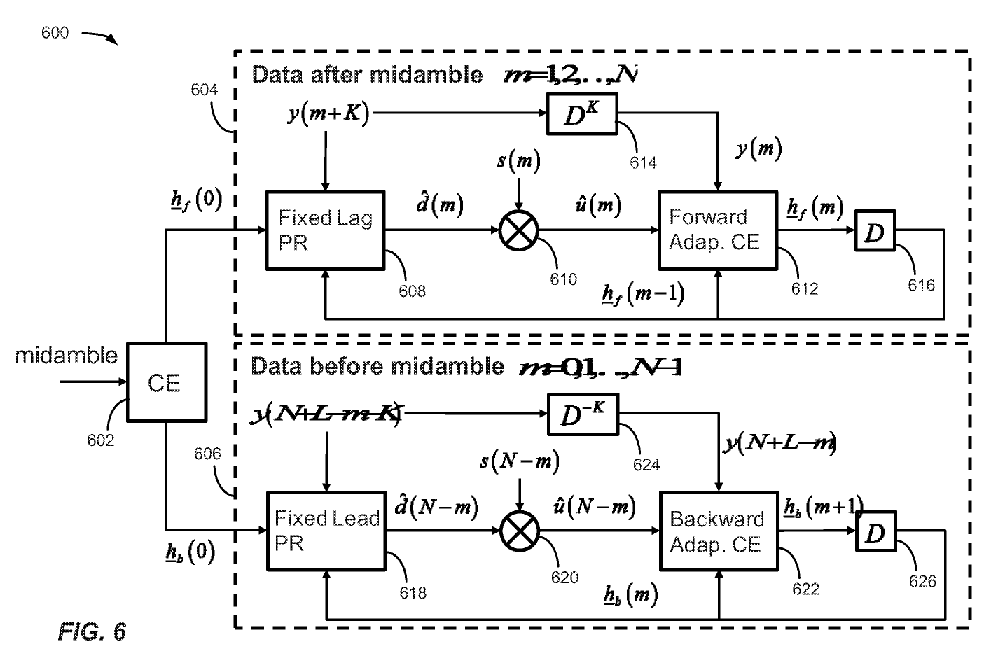

FIG. 6 is diagram 600 illustrating an example aspect of joint adaptive channel estimation and symbol detection by two-sided posterior recursion (fixed-lead and fixed-lead posterior recursions), which may be executed by UE 102 and/or receiver 114 and/or joint channel estimator and non-linear symbol detector component 110 and/or respective components thereof. As shown in FIG. 6, in some aspects, for example, UE 102 and/or receiver 114 and/or joint channel estimator and non-linear symbol detector component 110 and/or respective components thereof perform an initial channel estimation at block 602, and then, for data after the midamble, perform joint forward adaptive channel estimation and fixed-lag posterior recursion at block 604, and for data before the midamble, perform joint, backward adaptive channel estimation and fixed-lead posterior recursion at block 606.

More specifically, in some present aspects, in block 602, receiver 114 and/or joint, channel estimator and non-linear symbol detector component 110 and/or channel estimator component 128 perform initial channel estimation, based on a received midamble, for data before and after the midamble (h, (0) and h_{f} (0), respectively).

Then, in block 608, to perform joint forward adaptive channel estimation and fixed-lag symbol detection for data after the midamble, UE 102 and/or receiver 114 and/or joint channel estimator and non-linear symbol detector component 110 and/or symbol detector component 126 and/or fixed-lag symbol detector component 134 perform fixed-lag symbol detection (detecting a symbol based on a fixed number of future symbols) to detect a symbol, e.g., \hat{d}(m), using received symbol y(m+K) and channel estimate feedback h_{f} (m−1) from a previous iteration of block 604. Subsequently, in block 610, UE 102 and/or receiver 114 and/or joint channel estimator and non-linear symbol detector component 110 multiply symbol \hat{d}(m) by s(m) to determine û(m), and in block 612. UE 102 and/or receiver 114 and/or joint channel estimator and non-linear symbol detector component 110 and/or forward adaptive channel estimator component 130 determine new channel estimate h_{f} (m) based on û(m), delayed received signal y (m) (which is provided in block 614 based. on y(m+K)), and channel estimate feedback h_{f} (m−1) from a previous iteration of block 604. Finally, in block 616, UE 102 and/or receiver 114 and/or joint channel estimator and non-linear symbol detector component 110 send new channel estimate h_{f} (m) to be used in the next iteration of block 604.

Accordingly, in block 604, for data after the midamble, joint forward adaptive channel estimation and fixed-lag symbol detection is achieved.

Also, in sonic present aspects, to perform joint backward adaptive channel estimation and fixed-lead symbol detection for data after the midamble, in block 618, UE 102 and/or receiver 114 and/or joint channel estimator and non-linear symbol detector component 110 and/or symbol detector component 126 and/or fixed-lead symbol detector component 136 perform fixed-lead symbol detection (detecting a symbol based on a fixed number of previously received symbols) to detect a symbol, e.g., \hat{d}(N−m), using received symbol y(N+L−m−K) and channel estimate feedback h_{b} (m) from a previous iteration of block 606. Subsequently, in block 620, UE 102 and/or receiver 114 and/or joint channel estimator and non-linear symbol detector component 110 multiply symbol \hat{d}(N−m) by s(N−m) to determine û(N−m), and in block 622, UE 102 and or receiver 114 and/or joint channel estimator and non-linear symbol detector component 110 and/or backward adaptive channel estimator component 132 determine new channel estimate h_{b} (m−1) based on û(N−m), delayed received signal y (N+L−m) (which is provided in block 624 based on y(N+L−m−K)), and channel estimate feedback h_{b} (m) from a previous iteration of block 606.

Finally, in block 626, UE 102 and/or receiver 114 and/or joint channel estimator and non-linear symbol detector component 110 send new channel estimate h_{b} (m+1) to be used in the next iteration of block 606.

Accordingly, in block 606, for data before the midamble, joint backward adaptive channel estimation and fixed-lead symbol detection is achieved.

In some alternative aspects, various components of receiver 114 and/or joint channel estimator and non-linear symbol detector component 110 may perform computations in the logarithmic domain. For example, in some aspects, transition probability determiner component 120, forward probability determiner component 116, backward probability determiner component 118, and target posterior probability determiner component 124 may, respectively, determine the transition probability γ(m−1, m), the forward probability α(m), the backward probability β(m), and the target posterior probabilities Pr (d(m)|y₁^{m+K} and Pr(d(N−m)|y+1−m−K^{N+1}), according to:

$$γ ( m - 1 , m ) = - \frac{1}{{σ}^{2}} {\vert y ( m ) - \underline{u} ( m ) \underline{h} \vert}^{2}$$

$$α ( m ) = {max}_{d ( m - K )} ( α ( m - 1 ) + γ ( m - 1 , m ) )$$

$$β ( m - 1 ) = {max}_{d ( m )} ( γ ( m - 1 , m ) + β ( m ) )$$

$$Pr ( d ( m ) \vert {\underline{y}}_{1}^{m + K} ) = {max}_{{\underline{d}}^{tunnel} ( m + L - 1 ) \backslash d ( m )} ( α ( m + L - 1 ) + β ( m + L - 1 ) )$$

$$Pr ( d ( N - m ) \vert {\underline{y}}_{N + L - m - K}^{N + L} ) = {max}_{{\underline{d}}^{tunnel} ( N - m ) \backslash d ( N - m )} ( α ( N - m ) + β ( N - m ) )$$

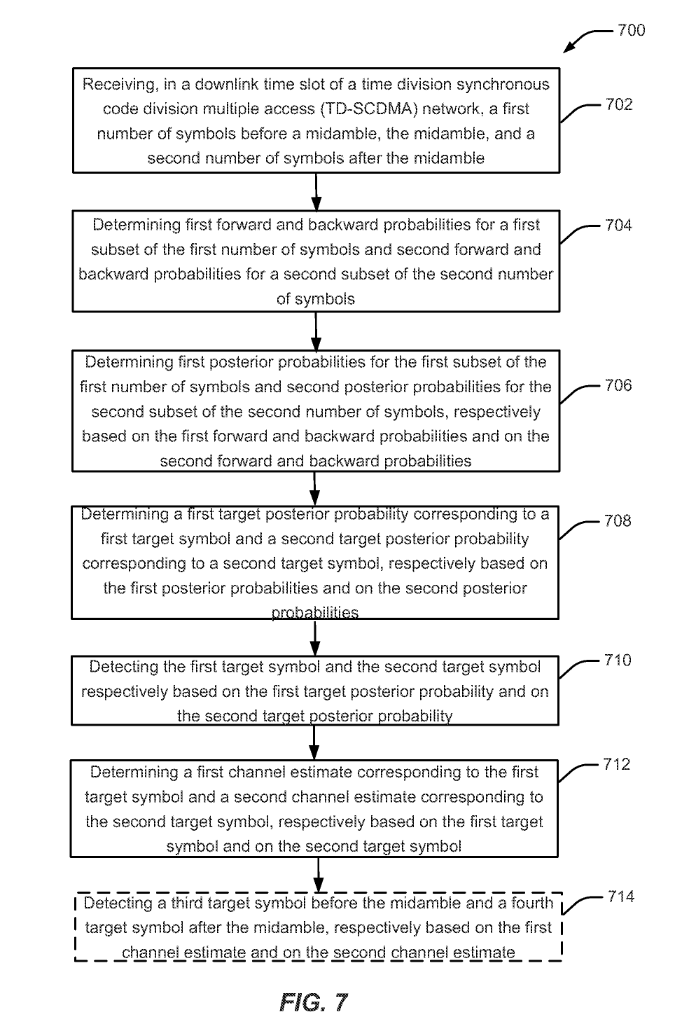

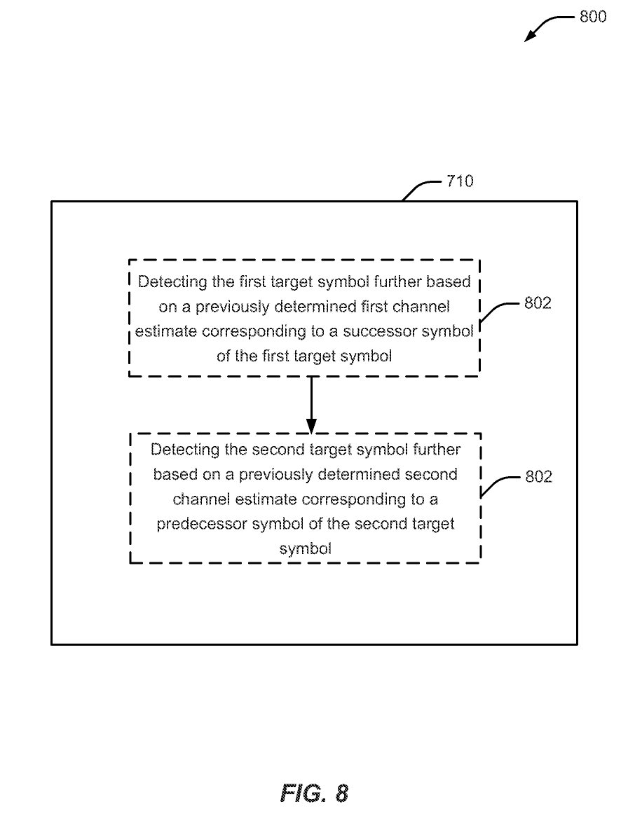

FIGS. 7-12 describe methods 700, 800, 900, 1000, 1100, 1200, respectively, in aspects of the wireless communications system of FIG. 1. For example, methods 700, 800, 900, 1000, 1100, 1200 may be performed by UE 102 executing receiver 114 and/or joint channel estimator and non-linear symbol detector component 110 (FIG. 1) as described herein, where method 700 relates to an aspect of joint channel estimation and non-linear symbol detection, method 800 relates to an aspect of detecting target symbols, method 900 relates to an aspect of determining a posterior probability of a symbol, method 1000 relates to an aspect of determining forward and backward probabilities, method 1100 relates to an aspect of determining target posterior probabilities, and method 1200 relates to a further aspect of detecting target symbols.

Referring now to FIG. 7, in an aspect of a method of wireless communication in which receiver 114, joint channel estimator and non-linear symbol detector component 110, and/or UE 102 perform joint channel estimation and symbol detection, at block 702, method 700 includes receiving, in a downlink time slot of a time division synchronous code division multiple access (TD-SCDMA) network, a first number of symbols before a midamble, the midamble, and a second number of symbols after the midamble For example, in some aspects, receiver 114 and/or joint channel estimation and non-linear symbol detector component 110 of UE 102 may receive, in a downlink timeslot of TD-SCDMA network 112, a first number of symbols before a midamble, the midamble, and a second number of symbols after the midamble, as described herein with reference to blocks 202, 204, and 206 of FIG. 2. In some aspects, for example, TD-SCDMA network 112 is a single cell network with a spreading factor of one.

At block 704, method 700 includes determining first forward and backward probabilities for a first subset of the first number of symbols and second forward and backward probabilities for a second subset of the second number of symbols For example, in some aspects, receiver 114 and/or joint channel estimator and non-linear symbol detector component 110 and/or a respective one of forward probability determiner component 116 and backward probability determiner 118 may determine first forward and backward probabilities for a first subset of the first number of symbols and second forward and backward probabilities for a second subset of the second number of symbols, For example, as described herein with reference to FIG. 4, for symbol d(m+L−1) after the midamble, forward probability α(m+L−1) and backward probability β(m+L−1) may be determined by recursions corresponding to indices between m+L−1 and m+K, equivalent to K−L+2 recursions. Also, for example, as described herein with reference to FIG. 5, for symbol d(N−m) before the midamble, forward probability α(N−m) and backward probability β(N−m) may be determined by recursions corresponding to indices between N−m+1 and N+L−m−K, equivalent to K−L+2 recursions.

At block 706, method 700 includes determining first posterior probabilities for the first subset of the first number of symbols and second posterior probabilities for the second subset of the second number of symbols, respectively based on the first forward and backward. probabilities and on the second forward and backward probabilities. For example, in some aspects, receiver 114 and/or joint channel estimator and non-linear symbol detector component 110 and/or tunnel posterior probability determiner component 122 may determine first posterior probabilities for the first subset of the first number of symbols and second posterior probabilities for the second subset of the second number of symbols, respectively based on the first forward and backward probabilities and on the second forward and backward probabilities. For example, tunnel posterior probability determiner component 122 may determine a posterior probability for symbol d(m+L−1) based on forward. probability α(m+L−1) and backward probability β(m+L−1), as described herein with reference to FIG. 4. Also, for example, tunnel posterior probability determiner component 122 may determine a posterior probability for symbol d(N−m) based on forward probability α(N−m) and backward probability β(N−m), as described herein with reference to FIG. 5.

At block 708, method 700 includes determining a first target posterior probability corresponding to a first target symbol and a second target posterior probability corresponding to a second target symbol, respectively based on the first posterior probabilities and on the second posterior probabilities. For example, in sonic aspects, receiver 114 and/or joint channel estimator and non-linear symbol detector component 110 and/or target posterior probability determiner component 124 may determine a target posterior probability for target symbol d(m) based on the posterior probabilities of symbols d(m+L−1) up to d(m+1), as described herein with reference to FIG. 4. Also, for example, in some aspects, receiver 114 and/or joint channel estimator and non-linear symbol detector component 110 and/or target posterior probability determiner component 124 may determine a target posterior probability for target symbol d(N−m) based on the posterior probabilities of symbols d(N−1) up to d(N−m−L+1), as described herein with reference to FIG. 5.

At block 710, method 700 includes detecting the first target symbol and the second target symbol respectively based on the first target posterior probability and on the second target posterior probability. For example, in some aspects, receiver 114 and/or joint channel estimator and non-linear symbol detector component 110 and/or symbol detector component 126 may detect target symbol d(m) based on the target posterior probability for the target symbol d(m) which was determined based on the posterior probabilities of the symbols d(m+L−1) up to d(m+1), as described herein with reference to FIG. 4. Also, for example, in some aspects, receiver 114 and/or joint channel estimator and non-linear symbol detector component 110 and/or symbol detector component 126 may detect target symbol d(N−m) based on the target posterior probability for the target symbol d(N−m) which was determined based on the posterior probabilities of the symbols d(N−m−1) up to d(N−m−L+1), as described herein with reference to FIG. 5.

At block 712, method 700 includes determining a first channel estimate corresponding to the first target symbol and a second channel estimate corresponding to the second target symbol, respectively based on the first target symbol and on the second target symbol. For example, in some aspects, receiver 114 and/or joint channel estimator and non-linear symbol detector component 110 and/or channel estimator component 128 may determine a channel estimate corresponding to a first target symbol after the midamble and another channel estimate corresponding to a second target symbol before the midamble, respectively based on the first target symbol and on the second target symbol, as described herein with reference to blocks 204 and 206 of FIG. 2.

Optionally, at block 714, method 700 includes detecting a third target symbol before the midamble and a fourth target symbol after the midamble respectively based on the first channel estimate and on the second channel estimate. For example, in some aspects, receiver 114 and/or joint channel estimator and non-linear symbol detector component 110 and/or symbol detector component 126 may detect a third target symbol before the midamble and a fourth target symbol after the midamble respectively based on the first channel estimate and on the second channel estimate. For example, symbol detector component 126 and/or fixed-lag symbol detector component 134 may detect a target symbol after the midamble based on a channel estimate corresponding to a predecessor symbol, as described herein with reference to block 608 of FIG. 6. Also, for example, symbol detector component 126 and/or fixed-lead symbol detector component 136 may detect a target symbol before the midamble based on a channel estimate corresponding to a successor symbol, as described herein with reference to block 618 of FIG. 6.

Referring to FIG, 8, method 800 includes further, and optional, aspects related to block 710 of method 700 of FIG. 7 for detecting target symbols.

At optional block 802, method 800 includes detecting the first target symbol further based on previously determined first channel estimate corresponding to a successor symbol of the first target symbol. For example, receiver 114 and/or joint channel estimator and non-linear symbol detector component 110 and/or symbol detector component 122 and/or fixed-lead symbol detector component 136 may detect a target symbol before the midamble based on a channel estimate corresponding to a successor symbol, as described herein with reference to block 618 of FIG. 6.

At optional block 804, method 800 includes detecting the second target symbol further based on a previously determined second channel estimate corresponding to a predecessor symbol of the second target symbol. For example, in some aspects, receiver 114 and/or joint channel estimator and non-linear symbol detector component 110 and/or symbol detector component 122 and/or fixed-lag symbol detector component 134 may detect target symbol after the midamble based on a channel estimate corresponding to a predecessor symbol, as described herein with reference to block 608 of FIG. 6.

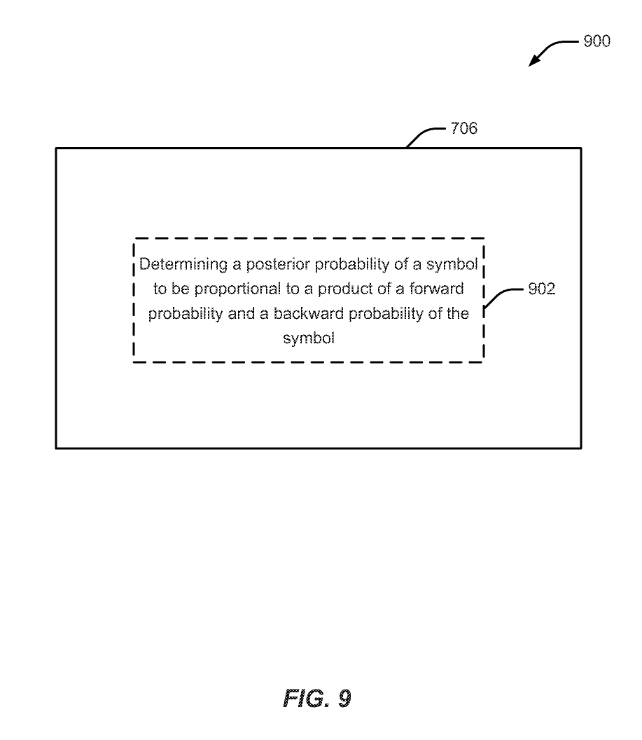

Referring to FIG. 9, method 900 includes further, and optional, aspects related to block 706 of method 700 for determining posterior probabilities.

At optional block 902, method 900 includes determining a posterior probability of a symbol to be proportional to a product of a forward probability and a backward probability of the symbol. For example, in some aspects, receiver 114 and/or joint channel estimator and non-linear symbol detector component 110 and/or posterior probability determiner component may determine a posterior probability of a symbol to be proportional to a product of a forward probability and a backward probability of the symbol, as described herein with reference to portion 404 of FIG. 400 and/or portion 502 of FIG. 500.

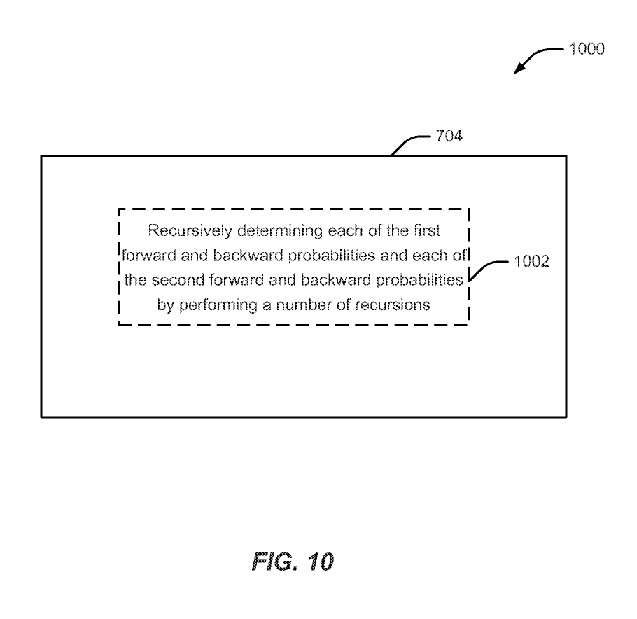

Referring to FIG. 10, method 1000 includes further, and optional, aspects related to block 706 of method 700 of FIG. 7 for determining forward and backward probabilities.

At optional block 1002, method 600 includes recursively determining each of the first forward and backward probabilities and each of the second forward and backward probabilities by performing a number of recursions. For example, in one aspect, receiver 114 and/or non-linear symbol detector component 110 and/or a respective one of forward probability determiner component 116 and backward probability determiner component 118 may recursively determine forward and backward probabilities for symbols after the midamble, e.g., for symbols between d(m+L−1) and d(m+K), by performing K−L+2 recursions as described herein with reference to FIG. 4. Also, for example, in one aspect, receiver 114 and/or non-linear symbol detector component 110 and/or a respective one of forward probability determiner component 116 and backward probability determiner component 118 may recursively determine forward and backward probabilities for symbols before the midamble, e.g., for symbols between d(N−m−K) and d(N−m+1−L), by performing K−L+2 recursions as described herein with reference to FIG. 5.

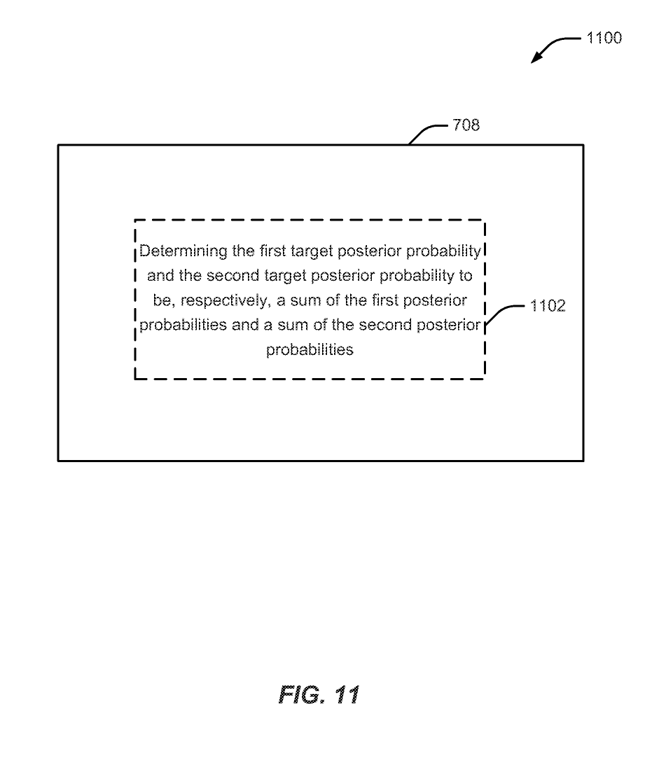

Referring to FIG. 11, method 1100 includes further, and optional, aspects related to block 708 of method 700 of FIG. 7 for determining target posterior probabilities.

At block 1102, method 1100 includes determining the first target posterior probability and the second target posterior probability to be, respectively, a sum of the first posterior probabilities and a sum of the second posterior probabilities. For example, in one aspect, receiver 114 and/or non-linear symbol detector component 110 and/or target posterior probability determiner component 124 may determine a target posterior probability for target symbol d(m) to be the sum of the posterior probabilities of symbols d(m+L−1) up to d(m+1), as described herein with reference to FIG. 4. Further, for example, in one aspect, receiver 114 and/or non-linear symbol detector component 110 and/or target posterior probability determiner component 124 may determine a target posterior probability for target symbol d(N−m) to be the sum of the posterior probabilities of symbols d(N−m−1) up to d(N−m−L+1), as described herein with reference to FIG. 5.

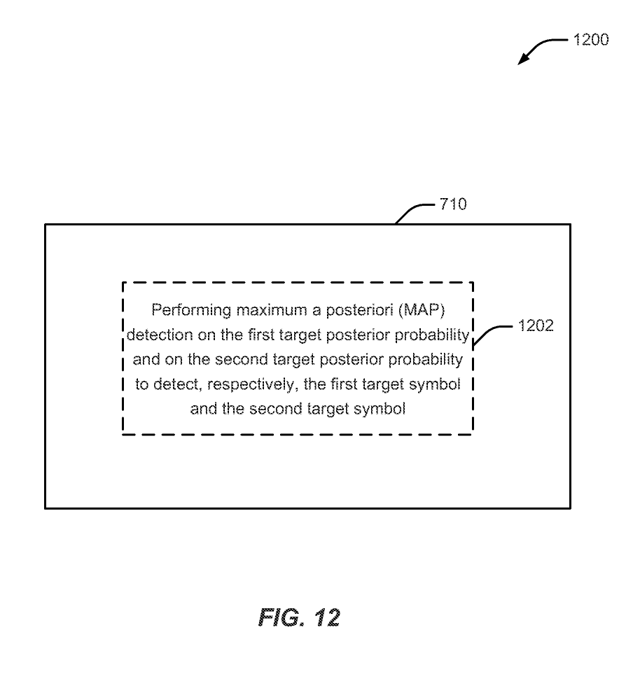

Referring to FIG. 12, method 1200 includes further, and optional, aspects related to block 710 of method 700 of FIG. 7 for detecting target symbols.

At optional block 1202, method 1200 includes performing MAP detection on the first target posterior probability and on the second target posterior probability to detect, respectively, the first target symbol and the second. target symbol. For example, in one aspect, receiver 114 and/or non-linear symbol detector component 110 and/or symbol detector component 126 fixed-lag MAP symbol detector component 126 may detect target symbol d(m) by performing MAP detection on a respective target posterior probability determined by target posterior probability determiner component 124, as described herein with reference to FIG. 4. Also, for example, in one aspect, receiver 114 and/or non-linear symbol detector component 110 and/or symbol detector component 126 fixed-lead MAP symbol detector component 136 may detect target symbol d(N−m) by performing MAP detection on a respective target posterior probability determined by target posterior probability determiner component 124, as described herein with reference to FIG. 5.

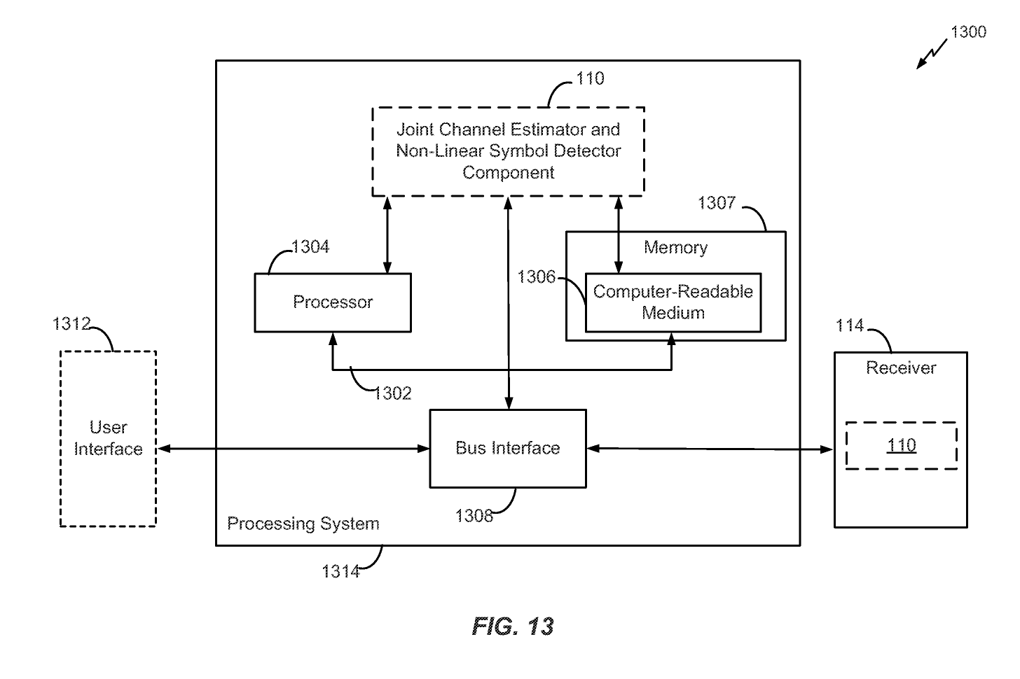

Referring to FIG. 13, an example of a hardware implementation for an apparatus 1300 including joint channel estimator and non-linear symbol detector component 110 and employing a processing system 1314 is shown. In an aspect, apparatus 1300 may be UE 102 of FIG. 1, including receiver 114, and may be configured to perform any functions described herein with reference to UE 102 and/or receiver 114 and/or non-linear symbol detector component 110. In this aspect, joint channel estimator and non-linear symbol detector component 110 is illustrated as being optionally implemented separate from, but in communication with, receiver 114. Further, in this aspect, joint channel estimator and non-linear symbol detector component 110 may be implemented as one or more processor modules in a processor 1304 of UE 102, as computer-readable instructions stored in a computer-readable medium 1306 in a memory 1307 of UE 102 and executed by processor 1304 of UE 102, or some combination of both.

In this example, the processing system 1314 may be implemented with a bus architecture, represented generally by the bus 1302. The bus 1302 may include any number of interconnecting buses and bridges depending on the specific application of the processing system 1314 and the overall design constraints. The bus 1302 links together various circuits including one or more processors, represented. generally by the processor 1301, one or more communications components, such as, for example, joint channel estimator and non-linear symbol detector component 110 of FIG. 1, and computer-readable media, represented generally by the computer-readable medium 1306. The bus 1302 may also link various other circuits such as timing sources, peripherals, voltage regulators, and power management circuits, which are well known in the art, and therefore, will not be described any further. A bus interface 1308 provides an interface between the bus 1302 and receiver 114, which may be part of a transceiver (not shown). The receiver 111 and/or transceiver (not shown) provide a means for communicating with various other apparatus over a transmission medium. Depending upon the nature of the apparatus, a user interface 1312 (e.g., keypad, display, speaker, microphone, joystick) may also be provided.

The processor 1304 is responsible for managing the bus 1302 and general processing, including the execution of software stored on the computer-readable medium 1306. For example, in some aspects, joint channel estimator and non-linear symbol detector component 110 may be software stored on the computer-readable medium 1306 and may be executed by processor 1304. The software, when executed by the processor 1304, causes the processing system 1314 to perform the various functions described herein for any particular apparatus.

The computer-readable medium 1306 may also be used for storing data that is manipulated by the processor 1304 when executing software, such as, for example, software modules represented by joint channel estimator and non-linear symbol detector component 110. In one example, the software modules (e.g., any algorithms or functions that may be executed by processor 1304 to perform the described functionality) and/or data used therewith (e.g., inputs, parameters, variables, and/or the like) may be retrieved from computer-readable medium 1306. The modules may be software modules running in the processor 1304, resident and/or stored in the computer-readable medium 1306, one or more hardware modules coupled to the processor 1304, or some combination thereof.

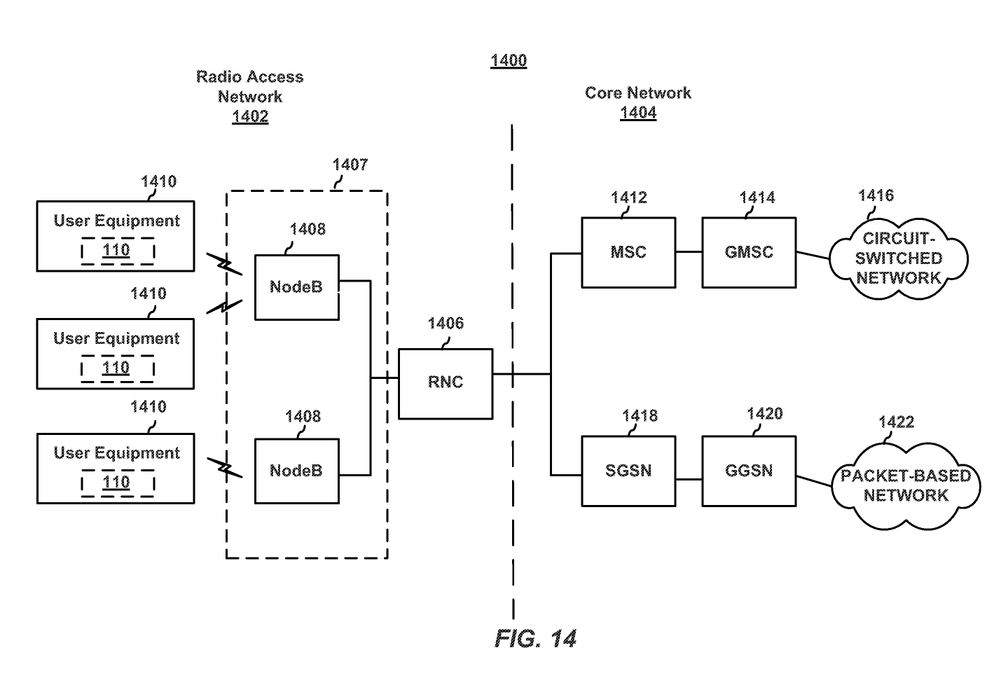

Turning now to FIG. 14, a block diagram is shown illustrating an example of a telecommunications system 1400. Telecommunications system 1400 includes UEs 1410 which may be examples of UE 102 of FIG. 1 and which may include and execute joint channel estimator and non-linear symbol detector component 110 to perform any functions described herein. The various concepts presented. throughout this disclosure may be implemented across a broad variety of telecommunication systems, network architectures, and communication standards. By way of example and without limitation, the aspects of the present disclosure illustrated in FIG. 14 are presented with reference to a UMTS system employing a TD-SCDMA standard. In this example, the UMTS system includes a (radio access network) RAN 1402 (e.g., UTRAN) that provides various wireless services including telephony, video, data, messaging, broadcasts, and/or other services. The RAN 1402 may be divided into a number of Radio Network Subsystems (RNSs) such as an RNS 1407, each controlled by a Radio Network Controller (RNC) such as an RNC 1406. For clarity, only the RNC 1406 and the RNS 1407 are shown; however, the RAN 1402 may include any number of RNCs and RNSs in addition to the RNC 1406 and RNS 1407. The RNC 1406 is an apparatus responsible for, among other things, assigning, reconfiguring and releasing radio resources within the RNS 1407. The RNC 1406 may be interconnected to other RNCs (not shown) in the RAN 1402 through various types of interfaces such as a direct physical connection, a virtual network, or the like, using any suitable transport network.

The geographic region covered by the RNS 1407 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 1408 are shown; however, the RNS 1407 may include any number of wireless Node Bs. The Node Bs 1408 provide wireless access points to a core network 1404 for any number of mobile apparatuses. Examples of a mobile apparatus include a cellular phone, a smart phone, a session initiation protocol (SIP) phone, a laptop, a notebook, a netbook, smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 1410, which may be the same as or similar to UE 102 of FIG. 1, are shown in communication with the Node Bs 1408, which may be the same as or similar to base station 104 of FIG. 1. The downlink (DL), also called the forward link, refers to the communication link from a Node B to a UE, and the uplink (UL), also called the reverse link, refers to the communication link from a UE to a Node B.

The core network 1404, as shown, includes a GSM core network. However, as those skilled in the art will recognize, the various concepts presented. throughout this disclosure may be implemented in a RAN, or other suitable access network, to provide UEs with access to types of core networks other than GSM networks.

in this example, the core network 1404 supports circuit-switched services with a mobile switching center (MSC) 1412 and a gateway MSC (GMSC) 1414. One or more RNCs, such as the RNC 1406, may be connected to the MSC 1412. The MSC 1412 is an apparatus that controls call setup, call routing, and UF mobility functions. The MSC 1412 also includes a visitor location register (VLR) (not shown) that contains subscriber-related information for the duration that a UE is in the coverage area of the MSC 1412. The GMSC 1414 provides a gateway through the MSC 1412 for the UE to access a circuit-switched network 1416. The GMSC 1414 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 1414 queries the HLR to determine the UE's location and forwards the call to the particular MSC serving that location.

The core network 1401 also supports packet-data services with a serving GPRS support node (SGSN) 1418 and a gateway GPRS support node (GGSN) 1420. GPRS, which stands for General Packet Radio Service, is designed to provide packet-data services at speeds higher than those available with standard GSM circuit-switched data services. The GGSN 1420 provides a connection for the RAN 1402 to a packet-based network 1422. The packet-based network 1122 may be the Internet, a private data network, or some other suitable packet-based network. The primary function of the GGSN 1420 is to provide the UEs 1410 with packet-based network connectivity. Data packets are transferred between the GGSN 1420 and the UEs 1410 through the SGSN 1418, which performs primarily the same functions in the packet-based domain as the MSC 1412 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 1408 and a UE 1410, but divides uplink and downlink transmissions into different time slots in the carrier.

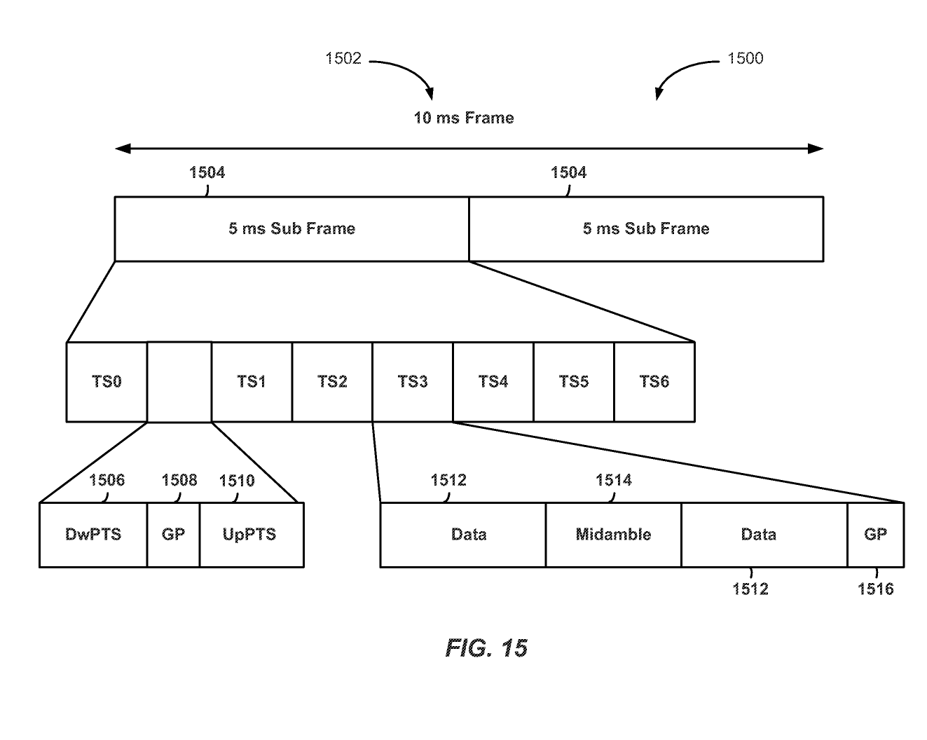

FIG. 15 shows a frame structure 1500 for a TD-SCDMA carrier, which may be used for communications between base station 104 of FIG. 1, and UE 102, also of FIG. 1. The TD-SCDMA carrier, as illustrated, has a frame 1502 that is 10 milliseconds (ms) in duration. The frame 1502 has two 5 ms subframes 1504, and each of the subframes 1504 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 1506, a guard period. (GP) 1508, and an uplink pilot time slot (UpPTS) 1510 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 1512 separated by a midamble 1514 and followed by a guard period (GP) 1516. The midamble 1514 may be used for features, such as channel estimation, while the GP 1516 may be used to avoid inter-burst interference.

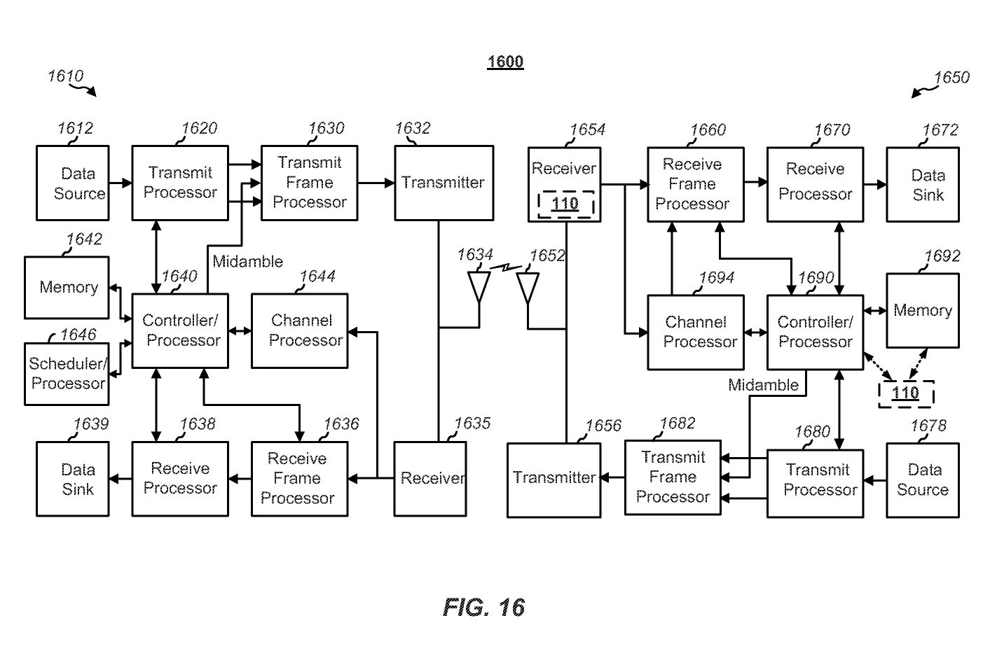

FIG. 16 is a block diagram of a Node B 1610 in communication with a UE 1650 in a RAN 1600. In an aspect, Node B 1610 may be an example of base station 104 of FIG. 1, and UE 1650 may be an example of UE 102 of FIG. 1 and may include and execute joint channel estimator and non-linear symbol detector component 110 of FIG. 1, either in receiver 1654 (which may be the same as or equivalent to receiver 114 of FIG. 1) or optionally separate from receiver 1654, for example, in memory 1692 and/or controller/processor 1690, to perform any functions described herein.

In the downlink communication, a transmit processor 1620 may receive data from a data source 1612 and control signals from a controller/processor 1640. The transmit processor 1620 provides various signal processing functions for the data and control signals, as well as reference signals (e.g., pilot signals). For example, the transmit processor 1620 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1644 may be used by a controller/processor 1640 to determine the coding, modulation, spreading, and/or scrambling schemes for the transmit processor 1620. These channel estimates may be derived from a reference signal transmitted by the LIE 1650 or from feedback contained in the midamble 1514 (FIG. 15) from the UE 1650. The symbols generated by the transmit processor 1620 are provided to a transmit frame processor 1630 to create a frame structure. The transmit frame processor 1630 creates this frame structure by multiplexing the symbols with a midamble 1514 (FIG. 15) from the controller/processor 1640, resulting in a series of frames. The frames are then provided to a transmitter 1632, which provides various signal conditioning functions including amplifying, filtering, and modulating the frames onto a carrier for downlink transmission over the wireless medium through smart antennas 1634. The smart antennas 1634 may be implemented with beam steering bidirectional adaptive antenna arrays or other similar beam technologies.

At the UE 1650, a receiver 1654 receives the downlink transmission through an antenna 1652 and processes the transmission to recover the information modulated onto the carrier. The information recovered by the receiver 1654 is provided to a receive frame processor 1660, which parses each frame, and provides the midamble 1514 (FIG. 15) to a channel processor 1694 and the data, control, and reference signals to a receive processor 1670. The receive processor 1670 then performs the inverse of the processing performed. by the transmit processor 1620 in the Node B 1610. More specifically, the receive processor 1670 descrambles and despreads the symbols, and then determines the most likely signal constellation points transmitted by the Node B 1610 based on the modulation scheme. These soft decisions may be based on channel estimates computed by the channel processor 1694. The soft decisions are then decoded and deinterleaved to recover the data, control, and reference signals. The CRC codes are then checked to determine whether the frames were successfully decoded. The data carried by the successfully decoded frames will then be provided to a data sink 1672, which represents applications running in the UE 1650 and/or various user interfaces (e.g., display). Control signals carried by successfully decoded frames will be provided to a controller/processor 1690. When frames are unsuccessfully decoded by the receiver processor 1670, the controller/processor 1690 may also use an acknowledgement (ACK) and/or negative acknowledgement (NACK) protocol to support retransmission requests for those frames.

In the uplink, data from a data source 1678 and control signals from the controller/processor 1690 are provided to a transmit processor 1680. The data source 1678 may represent applications running in the UE 1650 and various user interfaces (e.g., keyboard). Similar to the functionality described, in connection with the downlink transmission by the Node B 1610, the transmit processor 1680 provides various signal processing functions including CRC codes, coding and interleaving to facilitate FEC, mapping to signal constellations, spreading with OVSFs, and scrambling to produce a series of symbols. Channel estimates, derived by the channel processor 1694 from a reference signal transmitted by the Node B 1610 or from feedback contained in the midamble transmitted by the Node B 1610, may be used to select the appropriate coding, modulation, spreading, and/or scrambling schemes. The symbols produced by the transmit processor 1680 will be provided to a transmit frame processor 1682 to create a frame structure. The transmit frame processor 1682 creates this frame structure by multiplexing the symbols with a midamble 1514 (FIG. 15) from the controller/processor 1690, resulting in a series of frames. The frames are then provided to a transmitter 1656, which provides various signal conditioning functions including amplification, filtering, and modulating the frames onto a carrier for uplink transmission over the wireless medium through the antenna 1652.

The uplink transmission is processed at the Node B 1610 in a manner similar to that described in connection with the receiver function at the UE 1650. A receiver 1635 receives the uplink transmission through the antenna 1634 and processes the transmission to recover the information modulated onto the carrier, The information recovered by the receiver 1635 is provided to a receive frame processor 1636, which parses each frame, and provides the midamble 1514 (FIG. 15) to the channel processor 1644 and the data, control, and reference signals to a receive processor 1638. The receive processor 1638 performs the inverse of the processing performed by the transmit processor 1680 in the UE 1650. The data and control signals carried by the successfully decoded frames may then be provided to a data sink 1639 and the controller/processor, respectively. If some of the frames were unsuccessfully decoded by the receive processor, the controller/processor 1640 may also use an acknowledgement (ACK) and/or negative acknowledgement (NACK) protocol to support retransmission requests for those frames.

The controller/processors 1640 and 1690 may be used to direct the operation at the Node B 1610 and the UE 1650, respectively. For example, the controller/processors 1640 and 1690 may provide various functions including timing, peripheral interfaces, voltage regulation, power management, and other control functions. The computer readable media of memories 1642 and 1692 may store data and software for the Node B 1610 and the UE 1650, respectively. A scheduler/processor 1646 at the Node B 1610 may be used to allocate resources to the UEs and schedule downlink and/or uplink transmissions for the UEs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA.

Various aspects may also be extended to systems employing Long Term Evolution (LTE) (in FDD, TDD, or both modes), LTE-Advanced (LTE-A) (in FDD, TDD, Or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied, to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, or 35 U.S.C. § 112(f), whichever is appropriate, unless the element is expressly recited. using the phrase “means for” or, in the case of a method claim, the element is recited using the phrase “step for.”

What is claimed is:

1. A method of wireless communication, comprising:
receiving, in a downlink time slot of a time division synchronous code division multiple access (TD-SCDMA) network, a first number of symbols before a midamble, the midamble, and a second number of symbols after the midamble;
determining first forward and backward probabilities for a first subset of the first number of symbols and second forward and backward probabilities for a second subset of the second number of symbols;
determining first posterior probabilities for the first subset of the first number of symbols and second posterior probabilities for the second subset of the second number of symbols, respectively based on the first forward and backward probabilities and on the second forward and backward probabilities;
determining a first target posterior probability corresponding to a first target symbol and a second target posterior probability corresponding to a second target symbol, respectively based on the first posterior probabilities and on the second posterior probabilities;
detecting the first target symbol and the second target symbol respectively based on the first target posterior probability and on the second target posterior probability; and
determining a first channel estimate corresponding, to the first target symbol and a second channel estimate corresponding to the second target symbol respectively based on the first target symbol and on the second target symbol.

2. The method of claim 1, wherein detecting the first target symbol and the second target symbol comprises:
detecting the first target symbol further based on a previously determined first channel estimate corresponding to a successor symbol of the first target symbol; and
detecting the second target symbol further based on a previously determined second channel estimate corresponding to a predecessor symbol of the second target symbol.

3. The method of claim 1, further comprising:
detecting a third target symbol before the midamble and a fourth target symbol after the midamble respectively based on the first channel estimate and on the second channel estimate.

4. The method of claim 1, wherein determining the first posterior probabilities and the second posterior probabilities comprises:
determining a posterior probability of a symbol to be proportional to a product of a forward probability and a backward probability of the symbol.

5. The method of claim 1, wherein determining the first forward and backward probabilities and the second forward and backward probabilities comprises:
recursively determining each of the first forward and backward probabilities and each of the second forward and backward probabilities by performing a number of recursions.

6. The method of claim 1 wherein determining the first target posterior probability and the second target posterior probability comprises:
determining the first target posterior probability and the second target posterior probability to be, respectively, a sum of the first posterior probabilities and a sum of the second posterior probabilities.

7. The method of claim 1, wherein detecting the first target symbol and the second target symbol comprises:
performing maximum a posteriori (MAP) detection on the first target posterior probability and on the second target posterior probability to detect, respectively, the first target symbol and the second target symbol.

8. The method of claim 1, wherein the TD-SCDMA network is a single cell network with a spreading factor of one.

9. An apparatus for wireless communication, comprising:
a processing system configured to:
receive, in a downlink time slot of a time division synchronous code division multiple access (TD-SCDMA) network, a first number of symbols before a midamble, the midamble, and a second number of symbols after the midamble;
determine first forward and backward probabilities for a first subset of the first number of symbols and second forward and backward probabilities for a second subset of the second number of symbols;
determine first posterior probabilities for the first subset of the first number of symbols and second posterior probabilities for the second subset of the second number of symbols, respectively based on the first forward and backward probabilities and on the second forward and backward probabilities;
determine a first target posterior probability corresponding to a first target symbol and a second target posterior probability corresponding to a second. target symbol, respectively based on the first posterior probabilities and on the second posterior probabilities;
detect the first target symbol and the second target symbol respectively based on the first target posterior probability and on the second target posterior probability; and
determine a first channel estimate corresponding to the first target symbol and a second channel estimate corresponding to the second target symbol, respectively based on the first target symbol and on the second target symbol.

10. The apparatus of claim 9, wherein to detect the first target symbol and the second target symbol, the processing system is configured to:
detect the first target symbol further based on a previously determined first channel estimate corresponding to a successor symbol of the first target symbol; and
detect the second target symbol further based on a previously determined second channel estimate corresponding to a predecessor symbol of the second target symbol.

11. The apparatus of claim 9, wherein the processing system is further configured to;
detect a third target symbol before the midamble and a fourth target symbol after the midamble respectively based on the first channel estimate and on the second channel estimate.

12. The apparatus of claim 9, wherein to determine the first posterior probabilities and the second posterior probabilities, the processing system is configured to:
determine a posterior probability of a symbol to be proportional to a product of a forward probability and a backward probability of the symbol.

13. The apparatus of claim 9, wherein to determine the first forward and backward probabilities and the second forward and backward probabilities, the processing system is configured to:
recursively determine each of the first forward and backward probabilities and each of the second forward and backward probabilities by performing a number of recursions.

14. The apparatus of claim 9, wherein to determine the first target posterior probability and the second target posterior probability, the processing system is configured to:
determine the first target posterior probability and the second target posterior probability to be, respectively, a sum of the first posterior probabilities and a sum of the second posterior probabilities.

15. The apparatus of claim 9, wherein to detect the first target symbol and the second target symbol, the processing system is configured to:
perform maximum a posteriori (MAP) detection on the first target posterior probability and on the second target posterior probability to detect, respectively, the first target symbol and the second target symbol.

16. The apparatus of claim 9, wherein the TD-SCDMA network is a single cell network with a spreading factor of one.

17. An apparatus for wireless communication, comprising:
means for receiving, in a downlink time slot of a time division synchronous code division multiple access (TD-SCDMA) network, a first number of symbols before a midamble, the midamble, and a second number of symbols after the midamble;
means for determining first forward and backward probabilities for a first subset of the first number of symbols and second forward and backward probabilities for a second subset of the second number of symbols;
means for determining first posterior probabilities for the first subset of the first number of symbols and second posterior probabilities for the second subset of the second number of symbols, respectively based on the first forward and backward probabilities and on the second forward and backward probabilities;
means for determining a first target posterior probability corresponding to a first target symbol and a second target posterior probability corresponding to a second target symbol, respectively based on the first posterior probabilities and on the second posterior probabilities;
means for detecting the first target symbol and the second target symbol respectively based on the first target posterior probability and on the second target posterior probability; and
means for determining a first channel estimate corresponding to the first target symbol and a second channel estimate corresponding to the second target symbol, respectively based on the first target symbol and on the second target symbol.

18. The apparatus of claim 17, wherein the means for detecting the first target symbol and the second target symbol comprises:
means for detecting the first target symbol farther based on a previously determined first channel estimate corresponding to a successor symbol of the first target symbol; and
means for detecting the second target symbol farther based on a previously determined second channel estimate corresponding to a predecessor symbol of the second target symbol.

19. The apparatus of claim 17, further comprising:
means for detecting a third target symbol before the midamble and a fourth target symbol after the midamble respectively based on the first channel estimate and on the second channel estimate.

20. The apparatus of claim 17, wherein the means for determining the first posterior probabilities and the second posterior probabilities comprises:
means for determining a posterior probability of a symbol to be proportional to a product of a forward probability and a backward probability of the symbol.

21. The apparatus of claim 17, wherein the means for determining the first forward and backward probabilities and the second forward and backward probabilities comprises:
means for recursively determining each of the first forward and backward probabilities and each of the second forward and backward probabilities by performing a number of recursions.

22. The apparatus of claim 17, wherein the means for determining the first target posterior probability and the second target posterior probability comprises:
means for determining the first target posterior probability and the second target posterior probability to be, respectively, a sum of the first posterior probabilities and a sum of the second posterior probabilities.

23. The apparatus of claim 17, wherein the means for detecting the first target symbol and the second target symbol comprises:
means for performing maximum a posteriori (MAP) detection on the first target posterior probability and on the second target posterior probability to detect, respectively, the first target symbol and the second target symbol.

24. The apparatus of claim 17, wherein the TD-SCDMA network is a single cell network with a spreading factor of one.

25. A computer program product for wireless communication, comprising:
a non-transitory computer-readable medium comprising:
code for receiving, in a downlink time slot of a time division synchronous code division multiple access (TD-SCDMA) network, a first number of symbols before a midamble, the midamble, and a second number of symbols after the midamble;
code for determining first forward and backward probabilities for a first subset of the first number of symbols and second forward and backward probabilities for a second subset of the second number of symbols;
code for determining first posterior probabilities for the first subset of the first number of symbols and second posterior probabilities for the second subset of the second number of symbols, respectively based on the first forward and backward probabilities and on the second forward and backward probabilities;
code for determining a first target posterior probability corresponding to a first target symbol and a second target posterior probability corresponding to a second target symbol, respectively based on the first posterior probabilities and on the second posterior probabilities;
code for detecting the first target symbol and the second target symbol respectively based on the first target posterior probability and on the second target posterior probability; and
code for determining a first channel estimate corresponding to the first target symbol and a second channel estimate corresponding to the second target symbol, respectively based on the first target symbol and on the second target symbol.

26. The computer program product of claim 25, wherein the code for detecting the first target symbol and the second target symbol comprises:
code for detecting the first target symbol further based on a previously determined first channel estimate corresponding to a successor symbol of the first target symbol; and
code for detecting the second target symbol further based on a previously determined second channel estimate corresponding to a predecessor symbol of the second target symbol.

27. The computer program product of claim 25, wherein the non-transitory computer-readable medium further comprises:
code for detecting a third target symbol before the midamble and a fourth target symbol after the midamble respectively based on the first channel estimate and on the second channel estimate.

28. The computer program product of claim 25, wherein the code for determining the first posterior probabilities and the second posterior probabilities comprises:
code for determining a posterior probability of a symbol to be proportional to a product of a forward probability and a backward probability of the symbol.

29. The computer program product of claim 25, wherein the code for determining the first forward and backward probabilities and the second forward and backward probabilities comprises:
code for recursively determining each of the first forward and backward probabilities and each of the second forward and backward probabilities by performing a number of recursions.

30. The computer program product of claim 25, wherein the code for determining the first target posterior probability and the second target posterior probability comprises:
code for determining the first target posterior probability and the second target posterior probability to be, respectively, a sum of the first posterior probabilities and a sum of the second posterior probabilities.
